(19) United States
(12) Patent Application Publication
(10) Pub. No.: US 2018/0054683 A1
(43) Pub. Date: Feb. 22, 2018

(54) HEARING SYSTEM COMPRISING A HEARING DEVICE AND A MICROPHONE UNIT FOR PICKING UP A USER'S OWN VOICE

(71) Applicant: Oticon A/S, Smorum (DK)

(72) Inventors: Michael Syskind PEDERSEN, Smorum (DK); Adis BJELOSEVIC, Smorum (DK); Andreas Thelander BERTELSEN, Smorum (DK)

(73) Assignee: Oticon A/S, Smorum (DK)

(21) Appl. No.: 15/677,499

(22) Filed: Aug. 15, 2017

(30) Foreign Application Priority Data
Aug. 16, 2016 (EP) 16184252.1

(51) Int. Cl. H04R 25/00; G10L 21/0208

(52) U.S. Cl. CPC H04R 25/554; G10L 21/0208; H04R 25/505; H04R 2225/67; H04R 2225/43; H04R 2225/51; H04R 25/405

(57) ABSTRACT

A body worn hearing system comprises a hearing device, e.g. a hearing aid, and a separate microphone unit for picking up a voice of the user. The hearing device comprises a forward path comprising an input unit for providing an electric input signal representative of sound in the environment, a signal processing unit for providing a processed signal, and an output unit for generating stimuli perceivable as sound when presented to the user based on said processed signal. The microphone unit comprises a multitude M of microphones, and a multi-input noise reduction system for providing an estimate Ŝ of a target signal s comprising the user's voice, and comprising a multi-input beamformer filtering unit operationally coupled to said multitude of microphones. The hearing device and the microphone unit are configured to receive and transmit an audio signal from/to a communication device, respectively, and for establishing a communication link between them for exchanging information. The hearing system comprises a control unit configured to estimate a current distance between the user's mouth and the microphone unit, and to control the multi-input noise reduction system in dependence of said distance.

### SUMMARY

The present disclosure deals with a body worn hearing system, e.g. a hearing aid system. The hearing system comprises a hearing device, or a pair of hearing devices (e.g. hearing aids), and a separate microphone unit.

The present disclosure relates in particular to a hearing system configured to be used by a hearing impaired person (‘the user’) and comprising a separate microphone unit, e.g. in the form or a wireless, e.g. clip-on-, microphone unit, which may be used to transmit a user's own voice to a communication device, e.g. a telephone (such as a cellular telephone). Such a microphone unit may comprise an array of M microphones (i.e. M≧2), which by use of (e.g. adaptive) beamforming may enhance the voice of the person talking. Our co-pending European patent application no. EP16154471.3, filed with the EPO on 5 Feb. 2016, and published as EP3057337A1 deals with the same topic. In EP3057337A1, it is proposed to build a dedicated adaptive beamformer and single-channel noise reduction (SC-NR) algorithm into the separate microphone unit, which in a specific communication (e.g. telephone reception) situation is able to retrieve a voice signal of the user wearing the microphone unit from the noisy microphone signals received by the microphone unit, and to reject/suppress other sound sources.

A Hearing System:

The present disclosure proposes a number of features that can be used to improve a body worn hearing system in a communication mode, where a wearer's own voice is picked up (by a separate microphone unit) and transmitted to another device (a communication device).

As the person talking (e.g. the mouth of the person wearing the microphone unit) is close to the microphone unit, the sound of interest is in the acoustic near-field. When the sound of interest is in the near field, the sound pressure level at the (e.g. two) microphones may differ because one microphone is further away from the mouth compared to the other(s). The difference in sound pressure level will depend on the distance between the mouth and the microphone unit. If the microphone unit is relatively close to the mouth, the sound pressure level difference will be higher compared to the sound pressure level difference if the microphone unit is relatively further away from the mouth. When the sound is in the far-field, the relative distance between the microphones compared to the distance between the microphones and the sound source, becomes small, and the difference in sound pressure level between the microphones becomes insignificant. For near-field applications, in order to achieve an optimal directional response, we need to take into account that the transfer function (or impulse response) between the microphones not only depends on the direction to the sound source but also on the distance to the sound source, cf. FIG. 2A, 2B.

It is an object of the present disclosure to provide an alternative directional microphone system for picking up a user's voice in a body-worn hearing system. It is an object of an embodiment of a hearing system according to the present disclosure to provide a scheme for estimating a distance, or a propagation time delay, or (relative) transfer functions between the mouth of a user and microphones of a microphone unit and/or an angle between a reference direction of the microphone unit and a direction to the mouth of the user (when mounted on the body of the user). It is a further object to provide that parameters related to (e.g. dependent on) a current geometric configuration of the microphone unit relative to the mouth of the user (e.g. relative transfer functions RTFs, distances D, time delays Δt, or tilt angle θ) are updated at appropriate points in time (acoustic conditions) and used to control a noise reduction system (e.g. a beamformer filtering unit), at least in a specific communication mode of operation of the hearing system.

In an aspect of the present application, a body worn hearing system comprising a hearing device, e.g. a hearing aid, adapted for being located at or in an ear of a user, or adapted for being fully or partially implanted in the head of the user, and a separate microphone unit adapted for being located at said user and picking up a sound, e.g. a voice of the user, from the user's mouth, is provided.

The hearing device comprises
a forward path comprising an input unit for receiving an electric audio signal and/or for generating an electric input signal representative of sound in an environment of the hearing device, a signal processing unit for processing said electric audio signal or said electric input signal or a mixture thereof and providing a processed signal, and an output unit for generating stimuli perceivable as sound when presented to the user based on said processed signal, and
an antenna and transceiver unit for
   establishing a communication link to a communication device and configured to receive an audio signal from the communication device, at least in a specific communication mode of operation of the hearing system, and for
   establishing a communication link to the microphone unit for transmitting information to and/or receiving information from the microphone unit.

The microphone unit comprises
an input unit comprising a multitude M of microphones Mᵢ, i=1, . . . , M, each being configured for picking up or receiving a signal representative of a sound xi(n) from the environment of the microphone unit and providing respective electric input signals x′i(n), n representing time, and M being larger than or equal to two; and
a multi-input noise reduction system for providing an estimate Ŝ of a target signal s comprising the user's voice, the multi-input noise reduction system comprises a multi-input beamformer filtering unit operationally coupled to said multitude of microphones Mᵢ, i=1, . . . , M, and configured to provide a spatially filtered signal; and
an antenna and transceiver unit for
   establishing a communication link to a communication device and configured to transmit said estimate Ŝ of the user's voice to the communication device, at least in a specific communication mode of operation of the hearing system, and for
   establishing a communication link to the hearing device for transmitting information to and/or receiving information from the hearing device.

The hearing system comprises a control unit configured to estimate
a current distance between the user's mouth and the microphone unit, or
a current time delay for propagation of sound from a user's mouth to the microphone unit, and/or
relative transfer functions from the user's mouth to each of the M microphones relative to a reference microphone among the M microphones.

The hearing system is configured to control the multi-input noise reduction system in dependence of said current distance or said current time delay or said relative transfer functions.

Thereby an improved hearing system may be provided.

By estimating
a current distance D(MOUTH-MICU) (or time delay Δt(MOUTH-MICU)) between the user's mouth (MOUTH) and the microphone unit (MICU), possibly to each of the multitude M of microphones (Mᵢ, i=1, . . . , M), and/or
relative transfer functions RTF from the user's mouth to each of the M microphones relative to a reference microphone among the M microphones, and possibly
additionally a tilt angle θ of the microphone unit,

a set of beamformer weights of the beamformer filtering unit can be adaptively updated, e.g. by selecting an appropriate set of beamformer weights from a number of sets of beamformer weights (w(D (or Δt, or RTF), θ, k), k being a frequency index, k=1, . . . , K, where K is the number of frequency sub-bands). The data constitute a dictionary of beamformer weights corresponding to specific different values of distance D, or propagation time delay Δt, or relative transfer functions RTF (and possibly angle θ), are e.g. stored in a memory of the hearing system (or accessible to the hearing system).

In an embodiment, the dictionary comprises corresponding values of:

| | | |
|---|---|---|
| D1 (or time delay Δt1) | θ1 | w(D1 (or Δt1), θ1, k) |
| . . . | | |
| D1 (or time delay Δt1) | θN_{θ} | w(D1 (or Δt1), θN_{θ}, k) |
| . . . | | |
| DN_{D} (or time delay ΔtN_{D}), | θ1 | w(DN_{D} (or ΔtN_{D}), θ1, k) |
| . . . | | |
| DN_{D} (or time delay ΔtN_{D}), | θN_{θ}, | w(DN_{D} (or ΔtN_{D}), θN_{θ}, k) |

where k=1, . . . , K.

In an embodiment, the dictionary comprises values of relative transfer functions RTFₚ(D, θ, k) instead of, or in addition to, the beamformer weights w(D, θ, k).

In an embodiment, the dictionary comprises corresponding (e.g. predetermined) values of distance (or time delay), or relative transfer functions, and beamformer filtering weights for a number of different locations of the target sound source relative to the microphone unit, e.g. including the user's mouth, and one or more of a table and another person. In an embodiment, current estimates of the distance (or time delay) or relative transfer functions are used to determine where the microphone is located.

When tilt angle is included, a set of frequency dependent beamformer weights w(k) for each distance D (or time delay Δt, or relative transfer functions RTF) and each tilt angle θ is available in the dictionary (or database), i.e. in total N_{D} times N_{θ} sets of beamformer weights w(k). In an embodiment, such sets of beamformer weights are determined in advance of operation of the hearing system and stored on a medium accessible to the hearing system, e.g. in a memory of the microphone unit.

The distance D and propagation time delay Δt is tied together by the velocity of sound. For propagation in air, D(MO-Mi)=cₐᵢᵣ·Δt(MO-Mi), where the ‘variable’ MO-Mi represent a specific configuration of audio source (mouth, MO) and microphone (Mᵢ, i=1, . . . , M).

The spatially filtered signal from the beamformer filtering unit may be equal to the estimate of the target signal s comprising the user's voice. In an embodiment the spatially filtered signal is further processed (e.g. in a single channel noise reduction unit or other post-processing unit) to provide the estimate Ŝ of the target signal s (cf. e.g. FIG. 7).

In an embodiment, the control unit is configured to estimate a current distance or a current time delay (and/or relative transfer functions) from the user's mouth to the at least one, such as a majority or all, of the multitude M of microphones of the microphone unit. In an embodiment, the geometrical configuration of the multitude M of microphones Mᵢ, i=1, 2, . . . , M, is known (e.g. fixed within the microphone unit). In an embodiment, (at least some of, such as all of) the mutual distances Lᵢⱼ between the microphones are known (i=1, 2, . . . . , M, j=1, 2, . . . , M, while i≠j), and e.g. stored in a memory of the hearing system (or accessible to the hearing system). In an embodiment, the microphones are located on one straight line. In an embodiment, Lᵢⱼ=L for all j=i+1, i=1, 2, . . . , M−1. In an embodiment, M=2. In an embodiment, M=3. In an embodiment, M=4.

The term ‘a tilt angle θ of the microphone unit’ is in the presence context taken to mean an angle θ defined by the microphone unit (e.g. its housing, or a feature of the housing, e.g. an imprint or a mechanical protrusion or indentation, or any other characteristic feature of the microphone unit defining an axis) and a reference direction (e.g. a direction of the acceleration of gravity).

In an embodiment, the microphone unit comprises a housing wherein or whereon the multitude M of microphones are located, the housing defining a microphone unit reference direction MD_{REF}. In an embodiment, the microphone unit reference direction MD_{REF} is defined by or related to an edge or surface of the housing of the microphone unit. In an embodiment, the microphone unit reference direction MD_{REF} is defined by or related to a geometrical configuration of the multitude M of microphones. In an embodiment the microphone unit reference direction MD_{REF} is defined by or related to a microphone direction defined by two of the microphones of the multitude M of microphones (e.g. by a straight line through the two microphones). In an embodiment, the orientation of the microphone unit relative to a direction from the microphone unit to the user's mouth is defined by an angle between the microphone unit reference direction MD_{REF} and the direction MO-MD from the microphone unit to the user's mouth.

In an embodiment, the antenna and transceiver unit of the hearing device comprises separate first and second antenna and transceiver units, wherein
the first antenna and transceiver unit is configured to establish the communication link to the communication device and to receive an audio signal from the communication device, at least in a specific communication mode of operation of the hearing system, and wherein
the second antenna and transceiver unit is configured to establish the communication link to the microphone unit for transmitting information to and/or receiving information from the microphone unit.

In an embodiment, the first antenna and transceiver unit of the hearing device is configured to establish the communication link to the communication device and to additionally transmit information to the communication device, at least in a specific communication mode of operation of the hearing system.

In an embodiment, the antenna and transceiver unit of the microphone unit comprises separate first and second antenna and transceiver units, wherein
the first antenna and transceiver unit is configured to establish the communication link to the communication device and to transmit said estimate Ŝ of the user's voice to the communication device, at least in a specific communication mode of operation of the hearing system, and wherein
the second antenna and transceiver unit is configured to establish the communication link to the hearing device for transmitting information to and/or receiving information from the hearing device.

In an embodiment, the control unit is configured to estimate a current orientation of the microphone unit relative to a direction from the microphone unit to the user's mouth, and wherein the hearing system is configured to control the multi-input noise reduction system in dependence of the orientation of the microphone unit relative to a direction from the microphone unit to the user's mouth. If the microphone unit is tilted (so that a reference direction MD_{REF} of the microphone unit (e.g. an axis between two microphones) is not pointing in the direction of the mouth of the user), see e.g. FIG. 4, the look vector d may also depend on an angle θ between the direction to the mouth and the reference direction MD_{REF} of the microphone unit. We may thus find the best suitable (e.g. frequency dependent) directional beamformer weights w depending not only on the inter-microphone distance and the distance to the mouth (D1), but also on how much the microphone array is tilted (angle θ). Assuming that the body worn microphone unit is positioned below the mouth (so that the mouth-to-microphone unit direction is equal to or approximately equal to a vertical direction, the microphone array tilt may be estimated from a built-in orientation sensor, e.g. an accelerometer or a gyroscope, as the angle (θ′) between the microphone array and the direction of gravity.

The look vector d (RTF) is in the present context taken to be a representation of a normalized acoustic transfer function from a target sound source (at a given location, here the user's own voice, i.e. from the mouth of the user) to each microphone Mᵢ, i=1, . . . , M, of the microphone unit, i.e. d is an M dimensional vector. In an embodiment, d=d′/SQRT(|d′|²), where d′ is the un-normalized look vector.

In an embodiment, the input unit is configured to provide said time varying electric inputs signals x′ᵢ(n) as electric input signals Xᵢ(k,m) in a time-frequency representation comprising time varying signals in a number of frequency sub-bands, k being a frequency band index, m being a time index. In an embodiment, m is a time-frame index. In an embodiment, the multi-input noise reduction system is configured to determine filter weights w(k,m) for providing the spatially filtered (‘beamformed’) signal, wherein signal components from other directions than a direction of a target signal source are attenuated, whereas signal components from the direction of the target signal source are left un-attenuated or are attenuated less relative to signal components from said other directions. In an embodiment, the current distance (or delay or relative transfer functions) (at time m′) is used to select appropriate beamformer filter weights w(k,m′).

In an embodiment, the multi-input beamformer filtering unit is configured to be adaptive.

In an embodiment, a transfer function (and/or relative transfer function) from the target sound source (the user's mouth) to a microphone of the microphone unit is determined while the user is talking The transfer function may e.g. be determined when the hearing system is in a communication mode, e.g. during a telephone conversation, where a two-way (bi-directional) link to a ‘far-end person’ is established via a telephone and a telephone network (e.g. the Internet and/or via a public switched telephone network (PSTN)). In such situation, the user is likely to talk, if the far-away line from the ‘far-end person’ is quiet. In an embodiment, at least one of the left and right hearing devices HD_{L} and HD_{R}, are configured to receive a direct electric audio signal from a telephone (representing the voice of the far-end communication partner). In an embodiment, at least one of the left and right hearing devices comprises a voice or speech activity detector for determining whether (or with which probability) a voice is present in the received direct electric audio signal (the telephone signal). In an embodiment, the microphone unit, and/or the hearing device comprises an own voice detector for estimating whether (or with which probability) a user's own voice is present in the microphone signals picked up by the microphone unit and/or the hearing device. In an embodiment, the transfer functions (and/or relative transfer functions, or delay or distance) are estimated on initiation of a user (or as a standard procedure during power-on of the hearing system), e.g. via a user interface, e.g. under the condition that a detected environment sound level is below a threshold level (whereby a high SNR during estimation can be obtained). In an embodiment, an activation of the estimation of the transfer functions, etc., is indicated to the user via a loudspeaker of the hearing device(s) as an acoustic invitation to the user to speak, e.g. a predefined word or words or sentence(s), see e.g. FIG. 8. An estimate of the relevant parameters can then be performed when the user is speaking. The update of relevant parameters (e.g. the look vector d) during (own) voice or speech activity, and the determination of corresponding beamformer filtering weights is e.g. discussed in EP2882204A1 (cf. e.g. sections [0065]-[0080], in particular sections [0065] and [0072], respectively).

In an embodiment, the hearing device comprises a voice activity or speech detector configured to determining whether, or with which probability, a voice is present in the direct electric audio signal received from the communication device.

In an embodiment, the microphone unit comprises a voice or speech activity detector configured to determining whether, or with which probability, a voice or speech (in particular a user's own voice or speech) is present in the spatially filtered signal or in one or more of the electric input signals representative of sound from the environment of the microphone unit.

Voice activity information can e.g. be used to provide an adaptive noise reduction system (NRS) to control the timing of the update of the noise reduction system (e.g. update a look vector d when the user speaks (target sound source (=user's voice) is present), and update a noise covariance matrix Rᵥᵥ when the user does NOT speak. In an embodiment, this is indicated by a detection of no voice activity (update of d, assuming that the hearing system user speaks) and of voice/speech activity (update of Rᵥᵥ, assuming that the hearing system user does not speak) in the wirelessly received signal (i.e. from a speaker at ‘the other end’ of the telephone line).

In an embodiment, the hearing system comprises a single hearing device (only one). In an embodiment, the input unit of the hearing device comprises at least one microphone for converting a sound from the environment to an electric input signal. In an embodiment, the hearing system comprises left and right hearing devices, e.g. hearing aids, adapted for being located at or in respective left and right ear of a user, or adapted for being fully or partially implanted in the head at respective left and right ear of a user. In normal use, the distances D_{L} and/or D_{R} between the mouth and the left and right hearing devices HD_{L} and HD_{R}, respectively, do typically not vary much from day to day (where the hearing instruments have been dismounted and mounted again). But the distance between the body worn microphone unit and the mouth may be different every time the body worn microphone unit is mounted (the body worn microphone unit being a separate unit, that is mounted on the user's body (e.g. attached to the body, e.g. to clothing) independently of the hearing device(s)). In an embodiment, the hearing system comprises a detection unit configured to detect a difference in acoustic propagation time between sound from the user's mouth to the hearing device and to the microphone unit, respectively. In an embodiment, the detection unit is configured to detect a difference in acoustic propagation time between sound from the user's mouth to the at least one microphone of the hearing device and to one of the multitude M of microphones of the microphone unit, respectively. In an embodiment, the detection unit is configured to determine a similarity, e.g. a correlation, such as a cross correlation, between sound from the user's mouth received at the hearing device and at the microphone unit.

In an embodiment, the detection unit is configured to determine a cross correlation between sound from the user's mouth received at a microphone of the hearing device and sound received at one of the multitude M of microphones of the microphone unit. The cross-correlation is used to determine a difference in time of arrival (tₐ) of acoustic signals from the user's mouth to the respective microphones (thereby identifying the time difference Δt(HD-MICU)=tₐ(HD)−tₐ(MICU) that provides an optimal value of the cross-correlation. Knowing the distance D_{R} (and/or D_{L}) between the user's mouth and the hearing device (HD_{R}, HD_{L}) see FIG. 3), such values being e.g. determined in advance and stored in a (dynamically accessible) memory (e.g. of the hearing system), the distance D1 between the user's mouth and a microphone of the microphone unit can be approximated as D1=D_{L} (or D_{R})−Δt(HD-MICU)·cₐᵢᵣ, where cₐᵢᵣ is the velocity of sound in air. In an embodiment, the detection unit is configured to estimate the distance D1 between the user's mouth and a microphone of the microphone unit in a maximum likelihood framework, comprising a dictionary of corresponding distances, tilt angles, and look vectors (RTFs). Estimation of a direction of arrival of a target sound source in a maximum likelihood framework is e.g. discussed in [Farmani et al.; 2017].

In an embodiment, the microphone unit and/or the hearing device is/are configured to align the electric signals from the microphones in time, so that a given acoustic event (e.g. speech) is provided in the (aligned) signal streams at the same time. Thereby any given microphone signal may be selected for processing and/or presentation to the user (or a communication partner) at a given time in dependence of a current application or acoustic situation (e.g. own voice, acoustic feedback, reverberation, etc.).

In an embodiment, the hearing device(s) and the microphone unit are adapted to establish a communication link between them allowing information signals to be exchanged between them. In an embodiment, the information signals include audio signals (or parts of audio signals, e.g. selected frequency bands), and/or one or more parameters related to the current distance and/or direction from the user's mouth to the microphone unit, and/or current relative transfer functions from the user's mouth to the individual microphones of the microphone unit.

In an embodiment, the antenna and transceiver units of the hearing device and the microphone unit each comprises respective antenna coils configured to have an inductive coupling to each other that allow an inductive communication link to be established between the hearing device and the microphone unit when the hearing device and the microphone unit are mounted on the user's body, and wherein at least one of the hearing device and the microphone unit comprises at least two mutually angled antenna coils. In an embodiment, each antenna coil exhibits a coil axis defined by a center axis of a (virtual or physical) carrier around which the winding of the coil extends (around which the turns are wound). In an embodiment, the antenna and transceiver unit of the microphone unit comprises two or three mutually angled (e.g. orthogonal) antenna coils (in other words, the axes of the antenna coils are angled). In an embodiment, the antenna and transceiver unit of the hearing device comprises a single antenna coil. Assuming that the orientation of the coil-axis (or axes) of the antenna coil(s) of the hearing device when mounted on the user U is known and assuming that the orientation of the antenna coils of the microphone unit relative to the reference axis of the microphone unit is known, an orientation of the microphone unit relative to a global reference direction GD_{REF} (e.g. the direction of the force of gravity) can be determined based on the relative signal strengths of the electromagnetic signals received at the respective antenna coils of the microphone unit from the antenna coil of the hearing device.

In an embodiment, the hearing system is configured to be able to access a dictionary of beamformer weights (and/or relative transfer functions) and corresponding mouth to microphone unit distances, or time delays and optionally tilt angles. In an embodiment, the hearing system comprises a memory wherein a dictionary of beamformer weights and corresponding mouth to microphone distances, or time delays, or relative transfer functions, and optionally tilt angles is stored. In an embodiment, the microphone unit comprises said memory. In an embodiment, a number of different sets of beamformer weights corresponding to different distances Dₚ, p=1, . . . , N_{D}, between the mouth of the user and the microphone unit are stored in the memory. In this way, an appropriate set of beamformer weights can be chosen and applied, when a current distance (and/or direction (e.g. angle θ_{q}, q=1, . . . , N_{θ})) has been determined. In an embodiment, a number of different sets of beamformer weights corresponding to different distances Dₚ, p=1, . . . , N_{D}, (or corresponding propagation time delays Δtₚ) between the mouth of the user and the microphone unit, or relative transfer functions (RTFₚ), are stored in the memory together with a number of tilt angles θ_{q}, q=1, . . . , N_{θ} of the microphone unit for each distance Dₚ (or Δtₚ, or RTFₚ). In an embodiment, a current distance D′, or a current propagation time delay Δt′, or current relative transfer functions RTF′ is/are determined by the hearing system. In an embodiment, the hearing system is configured to select an appropriate set of beamformer weights (and or relative transfer functions)by testing each of the stored sets of beamformer weights w(Dₚ (or Δtₚ), k) and/or relative transfer functions RTFₚ(D, θ, k) corresponding to different tilt angles θ_{q}, q=1, . . . , N_{θ}, k=1, . . . , K, and to choose the set that optimizes the user's voice (e.g. using a maximum likelihood framework, where a likelihood function is determined and an estimated distance or tilt angle or beamformer weights is selected as the one corresponding to a maximum value of the likelihood function, cf. e.g. [Farmani et al.; 2017]).

In an embodiment, the (body worn) hearing system comprises a pair of hearing devices (e.g. denoted first and second hearing devices), e.g. adapted for being located at (or fully or partially implanted in) left and right ears, respectively, of a user. In an embodiment, the pair of hearing devices form part of a binaural hearing system, e.g. a binaural hearing aid system. In an embodiment, the left and right hearing devices each comprises antenna and transceiver circuitry allowing the exchange of information between them. In an embodiment, such information may comprise audio data and/or control signals and/or status signals.

In an embodiment, the (or each) hearing device comprises a hearing aid.

In an embodiment, the hearing system comprises a user interface allowing a user to influence functionality of the system. The user interface may be implemented fully or partially in the hearing device or in the microphone unit, or in an auxiliary device. In an embodiment, the hearing system is configured to allow an initiation of a procedure for updating current values of a look vector (RTFs, or distance D, or delay Δt).

In an embodiment, the hearing system comprises an auxiliary device implementing a user interface for the hearing system. In an embodiment, the auxiliary device (and the user interface) is configured to allow the exchange of information with the hearing system (e.g. the hearing device, and/or the microphone unit) via appropriate communication links. The user interface is preferably configured to allow a user to influence functionality of the hearing system, e.g. to enter or leave a specific communication mode according to the present disclosure. In an embodiment, the user interface is configured to allow a user to initiate an update of parameters (e.g. RTFs, D, Δt) related to (e.g. dependent on) a current geometric configuration of the microphone unit relative to the mouth of the user. The user interface may further be configured to allow presentation of information to a status of the hearing system. In an embodiment, the auxiliary device comprises a remote control device, e.g. a smartphone. In an embodiment, the user interface is implemented as an APP of a smartphone.

In an embodiment, the microphone unit is implemented in the auxiliary device together with a user interface, e.g. in smartphone.

In an embodiment, the hearing system is configured to initiate an update of parameters related to (e.g. dependent on) a current geometric configuration of the microphone unit relative to the mouth of the user (e.g. RTFs, D, Δt) during start-up (e.g. power on) of the system, during use (e.g. when specific criteria or acoustic conditions are fulfilled), or continuously, or allowing such initiation to be performed via a user interface (via a ‘user speech test’). The user interface may e.g. be implemented as a button on the hearing device, or as a remote control device (e.g. comprising an interactive display), or form part of an APP running on a cellular phone, e.g. a smartphone, a smartwatch, or similar portable or wearable device.

A Hearing Device:

In an aspect, a hearing device, e.g. a hearing aid, adapted for being located at or in an ear of a user, or adapted for being fully or partially implanted in the head of the user, is further provided by the present disclosure. The hearing aid is configured to form part of a hearing system as described above, in the detailed description of embodiments, and in the claims.

In an embodiment, the hearing device is adapted to provide a frequency dependent gain and/or a level dependent compression and/or a transposition (with or without frequency compression) of one or frequency ranges to one or more other frequency ranges, e.g. to compensate for a hearing impairment of a user. In an embodiment, the hearing device comprises a signal processing unit for enhancing the input signals and providing a processed output signal.

In an embodiment, the hearing device comprises an output unit for providing a stimulus perceived by the user as an acoustic signal based on a processed electric signal. In an embodiment, the output unit comprises a number of electrodes of a cochlear implant or a vibrator of a bone conducting hearing device. In an embodiment, the output unit comprises an output transducer. In an embodiment, the output transducer comprises a receiver (loudspeaker) for providing the stimulus as an acoustic signal to the user. In an embodiment, the output transducer comprises a vibrator for providing the stimulus as mechanical vibration of a skull bone to the user (e.g. in a bone-attached or bone-anchored hearing device).

In an embodiment, the hearing device comprises an input unit for providing an electric input signal representing sound. In an embodiment, the input unit comprises an input transducer, e.g. a microphone, for converting an input sound to an electric input signal. In an embodiment, the input unit comprises a wireless receiver for receiving a wireless signal comprising sound and for providing an electric input signal representing said sound. In an embodiment, the hearing device comprises a directional microphone system adapted to spatially filter sounds from the environment, and thereby enhance a target acoustic source among a multitude of acoustic sources in the local environment of the user wearing the hearing device. In an embodiment, the directional system is adapted to detect (such as adaptively detect) from which direction a particular part of the microphone signal originates. This can be achieved in various different ways as e.g. described in the prior art.

In an embodiment, the hearing device comprises an antenna and transceiver circuitry for establishing a wireless link to (e.g. wirelessly receiving a direct electric input signal from) another device, e.g. a communication device or another hearing device. In an embodiment, the communication between the hearing device and the other device is based on some sort of modulation at frequencies above 100 kHz. Preferably, frequencies used to establish a communication link between the hearing device and the other device is below 70 GHz, e.g. located in a range from 100 kHz to 50 MHz, or in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). In an embodiment, the wireless link is based on a standardized or proprietary technology. In an embodiment, the wireless link is based on Bluetooth technology (e.g. Bluetooth Low-Energy technology). In an embodiment, the wireless link is based on near-field communication, e.g. inductive communication.

In an embodiment, the hearing device is a portable device, e.g. a device comprising a local energy source, e.g. a battery, e.g. a rechargeable battery.

In an embodiment, the hearing device comprises a forward or signal path between an input transducer (microphone system and/or direct electric input (e.g. a wireless receiver)) and an output transducer. In an embodiment, the signal processing unit is located in the forward path. In an embodiment, the signal processing unit is adapted to provide a frequency dependent gain according to a user's particular needs. In an embodiment, the hearing device comprises an analysis path comprising functional components for analyzing the input signal (e.g. determining a level, a modulation, a type of signal, an acoustic feedback estimate, etc.). In an embodiment, some or all signal processing of the analysis path and/or the signal path is conducted in the frequency domain. In an embodiment, some or all signal processing of the analysis path and/or the signal path is conducted in the time domain.

In an embodiment, an analogue electric signal representing an acoustic signal is converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time tₙ (or n), each audio sample representing the value of the acoustic signal at tₙ by a predefined number Nₛ of bits, Nₛ being e.g. in the range from 1 to 48 bits, e.g. 24 bits. A digital sample x has a length in time of 1/fₛ, e.g. 50 μs, for fₛ=20 kHz. In an embodiment, a number of audio samples are arranged in a time frame. In an embodiment, a time frame comprises 64 or 128 audio data samples. Other frame lengths may be used depending on the practical application.

In an embodiment, the hearing devices comprise an analogue-to-digital (AD) converter to digitize an analogue input with a predefined sampling rate, e.g. 20 or 24 or 32 or 48 kHz. In an embodiment, the hearing devices comprise a digital-to-analogue (DA) converter to convert a digital signal to an analogue output signal, e.g. for being presented to a user via an output transducer.

In an embodiment, the hearing device, e.g. the microphone unit, and or the transceiver unit comprise(s) a TF-conversion unit for providing a time-frequency representation of an input signal. In an embodiment, the time-frequency representation comprises an array or map of corresponding complex or real values of the signal in question in a particular time and frequency range. In an embodiment, the TF conversion unit comprises a filter bank for filtering a (time varying) input signal and providing a number of (time varying) output signals each comprising a distinct frequency range of the input signal. In an embodiment, the TF conversion unit comprises a Fourier transformation unit for converting a time variant input signal to a (time variant) signal in the frequency domain. In an embodiment, the frequency range considered by the hearing device from a minimum frequency fₘᵢₙ to a maximum frequency fₘₐₓ comprises a part of the typical human audible frequency range from 20 Hz to 20 kHz, e.g. a part of the range from 20 Hz to 12 kHz. In an embodiment, a signal of the forward and/or analysis path of the hearing device is split into a number NI of frequency bands, where NI is e.g. larger than 5, such as larger than 10, such as larger than 50, such as larger than 100, such as larger than 500, at least some of which are processed individually. In an embodiment, the hearing device is/are adapted to process a signal of the forward and/or analysis path in a number NP of different frequency channels (NP≦NI). The frequency channels may be uniform or non-uniform in width (e.g. increasing in width with frequency), overlapping or non-overlapping.

In an embodiment, the hearing device (and/or the microphone unit) comprises a number of detectors configured to provide status signals relating to a current physical environment of the hearing device (e.g. the current acoustic environment), and/or to a current state of the user wearing the hearing device, and/or to a current state or mode of operation of the hearing device. Alternatively or additionally, one or more detectors may form part of an external device in communication (e.g. wirelessly) with the hearing device. An external device may e.g. comprise another hearing assistance device, a remote control, the microphone unit, an audio delivery device, a telephone (e.g. a Smartphone), an external sensor, etc.

In an embodiment, one or more of the number of detectors operate(s) on the full band signal (time domain). In an embodiment, one or more of the number of detectors operate(s) on band split signals ((time-) frequency domain).

In an embodiment, the number of detectors comprises a level detector for estimating a current level of a signal of the forward path. In an embodiment, the predefined criterion comprises whether the current level of a signal of the forward path is above or below a given (L-)threshold value. In an embodiment, the level detector or a control unit connected to the level detector is configured to estimate whether a current sound level is in a normal range for own voice levels (ΔLₒᵥ). In an embodiment, the level detector or a control unit connected to the level detector is configured to estimate whether a current sound level is below a predefined (background) threshold level (L_{bg}), where it can be assumed that the user's own voice is NOT present. The normal range for own voice levels (ΔLₒᵥ) and the predefined (background) threshold level (L_{bg}) may e.g. be predefined, e.g. measured or estimated in advance of (normal) use of the hearing system, E.g. stored in a memory of the hearing system (or accessible to the hearing system).

In an embodiment, the hearing system is configured to (automatically) estimate the parameters related to a current geometric configuration of the microphone unit relative to the mouth of the user (e.g. RTFs, D, Δt) when the current sound level is in a normal range for own voice levels (ΔLₒᵥ). In an embodiment, the hearing system is configured to initiate a user speech test (cf. e.g. FIG. 8) and subsequent estimate of the parameters related to a current geometric configuration of the microphone unit (e.g. RTFs, D, Δt) when the current sound level (in absence of speech, before the user speech test) is below the predefined (background) threshold level (L_{bg}).

In a particular embodiment, the hearing device comprises a voice detector (VD) for determining whether or not an input signal comprises a voice signal (at a given point in time). A voice signal is in the present context taken to include a speech signal from a human being. It may also include other forms of utterances generated by the human speech system (e.g. singing). In an embodiment, the voice detector unit is adapted to classify a current acoustic environment of the user as a VOICE or NO-VOICE environment. This has the advantage that time segments of the electric microphone signal comprising human utterances (e.g. speech) in the user's environment can be identified, and thus separated from time segments only comprising other sound sources (e.g. artificially generated noise).

In an embodiment, the voice detector is adapted to detect as a VOICE also the user's own voice. Alternatively, the voice detector is adapted to exclude a user's own voice from the detection of a VOICE.

In an embodiment, the hearing device comprises an own voice detector for detecting whether a given input sound (e.g. a voice) originates from the voice of the user of the system. In an embodiment, the microphone system of the hearing device is adapted to be able to differentiate between a user's own voice and another person's voice and possibly from NON-voice sounds.

In an embodiment, the hearing assistance device comprises a classification unit configured to classify the current situation based on input signals from (at least some of) the detectors, and possibly other inputs as well. In the present context ‘a current situation’ is taken to be defined by one or more of

a) the physical environment (e.g. including the current electromagnetic environment, e.g. the occurrence of electromagnetic signals (e.g. comprising audio and/or control signals) intended or not intended for reception by the hearing device, or other properties of the current environment than acoustic;

b) the current acoustic situation (input level, feedback, etc.), and

c) the current mode or state of the user (movement, temperature, etc.);

d) the current mode or state of the hearing assistance device (program selected, time elapsed since last user interaction, etc.) and/or of another device in communication with the hearing device (e.g. the microphone unit, and/or an auxiliary device).

In an embodiment, the hearing device further comprises other relevant functionality for the application in question, e.g. compression, feedback suppression, active noise cancellation, etc.

In an embodiment, the hearing device comprises a hearing aid, e.g. a hearing instrument, e.g. a hearing instrument adapted for being located at the ear or fully or partially in the ear canal of a user. In an embodiment, the hearing device comprises a hearing aid, a headset, an earphone, an ear protection device or a combination thereof.

Use:

In an aspect, use of a hearing system as described above, in the ‘detailed description of embodiments’ and in the claims, is moreover provided. In an embodiment, use is provided in a system comprising audio distribution. In an embodiment, use is provided in a system comprising one or more hearing aids (e.g. hearing instruments, headsets, ear phones, active ear protection systems, etc.), e.g. in handsfree telephone systems, teleconferencing systems, public address systems, karaoke systems, classroom amplification systems, etc.

An APP:

In a further aspect, a non-transitory application, termed an APP, is furthermore provided by the present disclosure. The APP comprises executable instructions configured to be executed on an auxiliary device to implement a user interface for a hearing device or a hearing system described above in the ‘detailed description of embodiments’, and in the claims. In an embodiment, the APP is configured to run on a cellular phone, e.g. a smartphone, or on another portable device allowing communication with said hearing device or said hearing system.

Definitions:

The ‘near-field’ of an acoustic source is a region close to the source where the sound pressure and acoustic particle velocity are not in phase (wave fronts are not parallel). In the near-field, acoustic intensity can vary greatly with distance (compared to the far-field). The near-field is generally taken to be limited to a distance from the source equal to about a wavelength of sound. The wavelength of sound is given by λ=c/f, where c is the speed of sound in air (cₐᵢᵣ=343 m/s, @ 20° C.) and f is frequency. At f=1 kHz, e.g., the wavelength of sound is 0.343 m (i.e. 34 cm). In the acoustic ‘far-field’, on the other hand, wave fronts are parallel and the sound field intensity decreases by 6 dB each time the distance from the source is doubled (inverse square law).

In the present context, a ‘hearing device’ refers to a device, such as e.g. a hearing aid, or a hearing instrument or an active ear-protection device or other audio processing device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. A ‘hearing device’ further refers to a device such as an earphone or a headset adapted to receive audio signals electronically, possibly modifying the audio signals and providing the possibly modified audio signals as audible signals to at least one of the user's ears. Such audible signals may e.g. be provided in the form of acoustic signals radiated into the user's outer ears, acoustic signals transferred as mechanical vibrations to the user's inner ears through the bone structure of the user's head and/or through parts of the middle ear as well as electric signals transferred directly or indirectly to the cochlear nerve of the user.

The hearing device may be configured to be worn in any known way, e.g. as a unit arranged behind the ear with a tube leading radiated acoustic signals into the ear canal or with a loudspeaker arranged close to or in the ear canal, as a unit entirely or partly arranged in the pinna and/or in the ear canal, as a unit attached to a fixture implanted into the skull bone, as an entirely or partly implanted unit, etc. The hearing device may comprise a single unit or several units communicating electronically with each other.

More generally, a hearing device comprises an input transducer for receiving an acoustic signal from a user's surroundings and providing a corresponding input audio signal and/or a receiver for electronically (i.e. wired or wirelessly) receiving an input audio signal, a (typically configurable) signal processing circuit for processing the input audio signal and an output means for providing an audible signal to the user in dependence on the processed audio signal. In some hearing devices, an amplifier may constitute the signal processing circuit. The signal processing circuit typically comprises one or more (integrated or separate) memory elements for executing programs and/or for storing parameters used (or potentially used) in the processing and/or for storing information relevant for the function of the hearing device and/or for storing or logging information (e.g. processed information, e.g. provided by the signal processing circuit), e.g. for use in connection with an interface to a user and/or an interface to a programming device. In some hearing devices, the output means may comprise an output transducer, such as e.g. a loudspeaker for providing an air-borne acoustic signal or a vibrator for providing a structure-borne or liquid-borne acoustic signal. In some hearing devices, the output means may comprise one or more output electrodes for providing electric signals.

In some hearing devices, the vibrator may be adapted to provide a structure-borne acoustic signal transcutaneously or percutaneously to the skull bone. In some hearing devices, the vibrator may be implanted in the middle ear and/or in the inner ear. In some hearing devices, the vibrator may be adapted to provide a structure-borne acoustic signal to a middle-ear bone and/or to the cochlea. In some hearing devices, the vibrator may be adapted to provide a liquid-borne acoustic signal to the cochlear liquid, e.g. through the oval window. In some hearing devices, the output electrodes may be implanted in the cochlea or on the inside of the skull bone and may be adapted to provide the electric signals to the hair cells of the cochlea, to one or more hearing nerves, to the auditory brainstem, to the auditory midbrain, to the auditory cortex and/or to other parts of the cerebral cortex.

A ‘hearing system’ refers to a system comprising one or two hearing devices, and a ‘binaural hearing system’ refers to a system comprising two hearing devices and being adapted to cooperatively provide audible signals to both of the user's ears. Hearing systems or binaural hearing systems may further comprise one or more ‘auxiliary devices’, which communicate with the hearing device(s) and affect and/or benefit from the function of the hearing device(s). Auxiliary devices may be e.g. remote controls, audio gateway devices, mobile phones (e.g. SmartPhones), public-address systems, car audio systems or music players. Hearing devices, hearing systems or binaural hearing systems may e.g. be used for compensating for a hearing-impaired person's loss of hearing capability, augmenting or protecting a normal-hearing person's hearing capability and/or conveying electronic audio signals to a person.

Embodiments of the disclosure may e.g. be useful in applications such as hearing aids, headsets, active ear protection systems, or combinations thereof. The disclosure may further be useful in applications combining hearing aids with communication devices, such as headsets, handsfree telephone systems, mobile telephones, teleconferencing systems, public address systems, karaoke systems, classroom amplification systems, etc.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1A shows a first exemplary use scenario of a hearing system according to the present disclosure comprising a microphone unit and a pair of hearing devices, FIG. 1A illustrating a scenario where audio signals are transmitted to the hearing devices from the telephone via the microphone unit, and

FIG. 1B shows a second exemplary use scenario of a hearing system according to the present disclosure comprising a microphone unit and a pair of hearing devices, FIG. 1B illustrating a scenario where audio signals are transmitted to the hearing devices directly from the telephone,

FIG. 2A shows a user wearing a hearing system comprising a pair of hearing devices and a microphone unit for picking up the user's own voice according to the present disclosure, the microphone unit being located at a first distance from the user's mouth, and

FIG. 2B a user wearing a hearing system comprising a pair of hearing devices and a microphone unit for picking up the user's own voice according to the present disclosure, the microphone unit being located at a second distance from the user's mouth,

FIG. 3 shows a user wearing a hearing system comprising a pair of hearing devices and a microphone unit for picking up the user's own voice according to the present disclosure, and illustrates a scheme for determining a distance between the user's mouth and the microphones of a microphone unit,

FIG. 4 shows a user wearing a hearing system comprising a pair of hearing devices and a microphone unit for picking up the user's own voice according to the present disclosure, and illustrates a scheme for determining a direction of the microphone unit relative to a global reference direction,

FIG. 5 shows a user wearing a hearing system comprising a pair of hearing devices and a microphone unit for picking up the user's own voice according to the present disclosure, and illustrates a situation where a wireless link between the microphone unit and the hearing devices is based on magnetic induction,

FIG. 6A shows a first location and orientation of a microphone unit on a user, and

FIG. 6B shows a second location and orientation of a microphone unit on a user,

FIG. 7 shows an exemplary block diagram of an embodiment of a hearing system according to the present disclosure comprising a microphone unit and a hearing device,

FIG. 8 illustrates a scenario for updating distances or time delays or relative transfer functions at a specifically selected point in time (during a ‘user speech test’), and

FIG. 9 illustrates an embodiment of a hearing device according to the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practised without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include microprocessors, microcontrollers, digital signal processors (DSPs), field programmable gate arrays (FPGAs), programmable logic devices (PLDs), gated logic, discrete hardware circuits, and other suitable hardware configured to perform the various functionality described throughout this disclosure. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing devices, e.g. hearing aids.

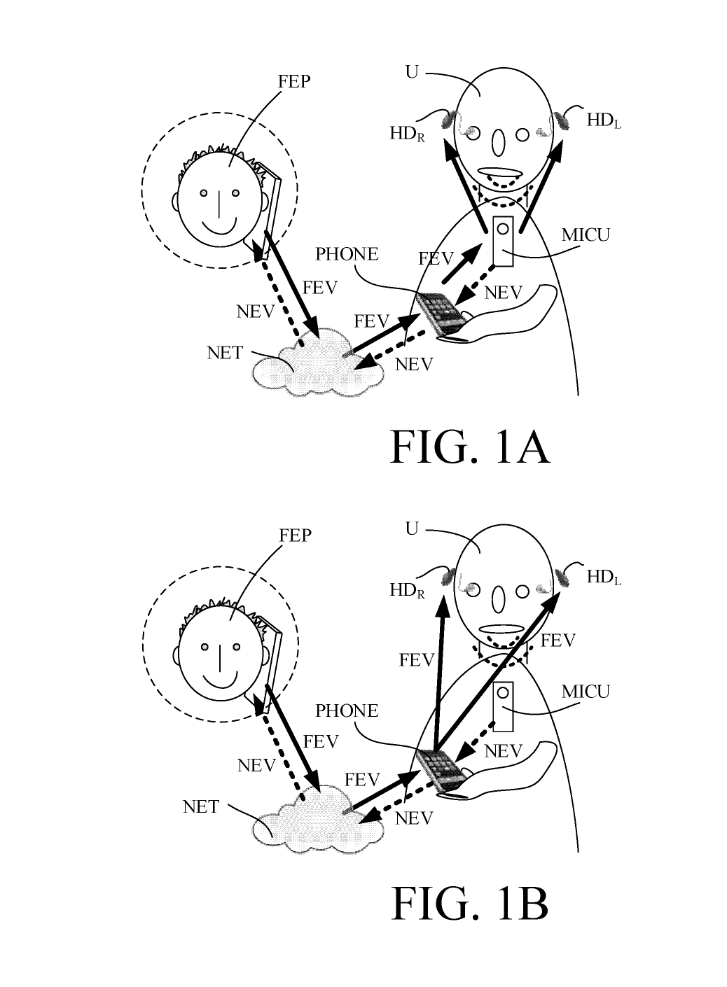

FIGS. 1A and 1B shows respective exemplary use scenarios of a hearing system according to the present disclosure comprising a microphone unit and a pair of hearing devices. In FIGS. 1A and 1B, dashed arrows (denoted NEV, near-end-voice) indicate (audio) communication from the hearing device user (U), containing the user's voice when he or she speaks or otherwise uses the voice, as picked up fully or partially by the microphone unit (MICU), to the far-end listener (FEP). This is the situation where the proposed microphone unit noise reduction system is active. Solid arrows (denoted FEV) indicate (audio) signal transmission (far-end-voice, FEV) from the far-end talker (FEP) to the hearing device user (U) (presented via hearing aids HD_{L}, HD_{R}), this communication containing the far end person's (FEP) voice when he or she speaks or otherwise uses the voice. The communication via a ‘telephone line’ as illustrated in FIGS. 1A and 1B is typically (but not necessarily) ‘half duplex’ in the sense that only the voice of one person at a time is present. The communication between the user (U) and the person (FEP) at the other end of the communication line is conducted via the user's telephone (PHONE), a network (NET), e.g. a public switched telephone network, and a telephone of the far-end-person (FEP). In the embodiments of a hearing system illustrated in FIGS. 1A and 1B, the user (U) is wearing a binaural hearing aid system comprising left and right hearing devices (e.g. hearing aids HD_{L}, HD_{R}) at the left and right ears of the user. The left and right hearing aids (HD_{L}, HD_{R}) are preferably adapted to allow the exchange of information (e.g. control signals, and possibly audio signals, or parts thereof) between them via an interaural communication link (e.g. a link based on near-field communication, e.g. an inductive link). The user wears the microphone unit (MICU) on the chest (e.g. in a neck-loop or attached to clothing by a clip of the microphone unit), appropriately positioned in distance and orientation to pick up the user's voice via built in microphones (e.g. two or more microphones, e.g. a microphone array). The user holds a telephone, e.g. a cellular telephone (e.g. a SmartPhone) in the hand. The telephone may alternatively be worn or held or positioned in any other way allowing the necessary communication to and from the telephone (e.g. around the neck, in a pocket, attached to a piece of clothing, attached to a part of the body, located in a bag, positioned on a table, etc.).

FIG. 1A illustrates a scenario where audio signals, e.g. comprising the voice (FEV) of a far-end-person (FEP), are transmitted to the hearing devices (HD_{L}, HD_{R}) from the telephone (PHONE) at the user (U) via the microphone unit (MICU). In this case, the hearing system is configured to allow an audio link to be established between the microphone unit (MICU) and the left and right hearing devices (HD_{L}, HD_{R}). Specifically, the microphone unit comprises antenna and transceiver circuitry (at least) to allow the transmission of (e.g. ‘far-end’) audio signals (FEV) from the microphone unit to each of the left and right hearing devices. This link may e.g. be based on far-field communication, e.g. according to a standardized (e.g. Bluetooth or Bluetooth Low Energy) or proprietary scheme. Alternatively, the link may be based on near-field communication, e.g. utilizing magnetic induction.

FIG. 1B illustrates a scenario where audio signals, e.g. comprising the voice (FEV) of a far-end-person (FEP), are transmitted to the hearing devices (HD_{L}, HD_{R}) directly from the telephone (PHONE) at the user (U, instead of via the microphone unit). In this case, the hearing system is configured to allow an audio link to be established between the telephone (PHONE) and the left and right hearing devices (HD_{L}, HD_{R}). Specifically, the left and right hearing devices (HD_{L}, HD_{R}) comprises antenna and transceiver circuitry to allow (at least) the reception of (e.g. ‘far-end’) audio signals (FEV) from the telephone (PHONE). This link may e.g. be based on far-field communication, e.g. according to a standardized (e.g. Bluetooth or Bluetooth Low Energy) or proprietary scheme.

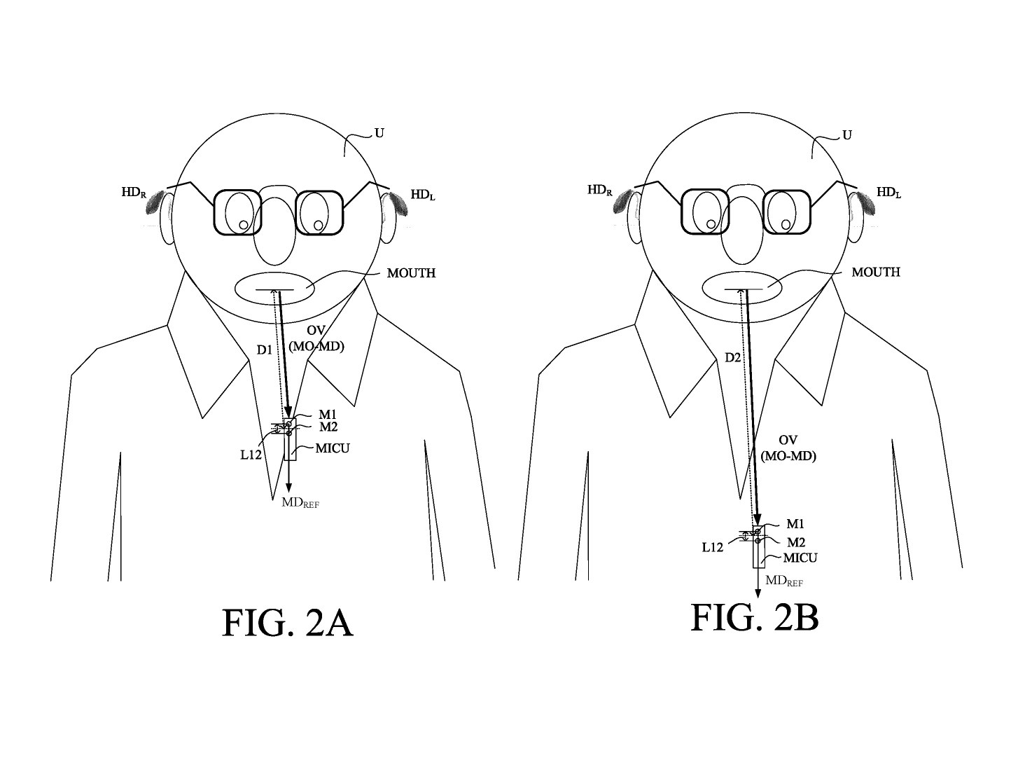

FIGS. 2A and 2B show a user wearing a hearing system comprising a pair of hearing devices and a microphone unit for picking up the user's own voice according to the present disclosure, the microphone unit being located at a first and second distances, respectively, from the user's mouth.

Compared to hearing instruments (HD_{L}, HD_{R}) which always are positioned at essentially the same location, a body-worn microphone unit MICU, e.g. comprising a microphone array, may be positioned different each time it is mounted as illustrated by the different positions of the microphone unit MICU in FIGS. 2A and 2B (cf. different distances D1 and D2 between the mouth (MOUTH) of the user U (the sound source) and the microphone unit MICU in FIGS. 2A and 2B). In order to achieve a good directional performance of the sound of interest (speech from the person wearing the microphone unit), it is important to know the direction from the microphones to the sound source of interest. Because the sound of interest is close to the microphones, the sound pressure level will be different at the two microphones (acoustic near-field), and the difference between the sound pressure level at the microphones will depend on the distance between the mouth (MOUTH) and the microphones (M1, M2). For that reason, not only the direction to the sound source of interest but also the distance between the sound source of interest and the microphones should be known in order to achieve good directional performance. In FIG. 2A, 2B the distance between the mouth and the respective microphones is defined by the mouth to microphone unit distance (D1, D2) and the inter-microphone distance L12 (here the distance between microphones M1 and M2). The mouth-to-microphone unit distances (D1, D2) are shown to be counted from the middle of the mouth to midway between microphone M1 and M2 of the microphone unit. A mouth-to-microphone unit direction MO-MD is shown as the bold arrow denoted OV (MO-MD) in FIG. 2A, 2B. A reference direction (arrow denoted MD_{REF}) of the microphone unit MICU may e.g. be defined by a housing of the microphone unit (e.g. an edge) or (as indicated in FIG. 2A, 2B) by an axis defined relative to the microphones of the microphone unit (here through the first and second microphones M1, M2).

In order to achieve a good directional performance using the microphone array of the microphone unit, it may be advantageous to have a good estimate of the transfer function between the source of interest and the different microphones, or alternatively the relative (normalized) transfer functions (RTF) between the microphones with respect to the source of interest. We term this transfer function ‘the look vector d’. In other words, the look vector d is a representation of the (e.g. relative) acoustic transfer function from a target sound source (here the user's own voice, i.e. from the mouth of the user) to each microphone of the microphone unit. The look vector is preferably determined (either in advance of the use of the hearing system or adaptively) while a target (the user's voice) signal is present or dominant (e.g. present with a high probability, e.g. ≧70%) in the electric input signals of the microphones of the microphone unit. Inter-microphone covariance matrices and an eigenvector corresponding to a dominant eigenvalue of the covariance matrix are determined based thereon (cf. e.g. EP2701145A1, or EP2882204A1). The eigenvector corresponding to the dominant eigenvalue of the covariance matrix is the look vector d. The look vector depends on the relative location of the target signal to the microphones of the microphone unit (and the propagation properties of the acoustic channel from the target sound source to the respective microphones (M1, M2) of the microphone unit MICU.

There are different ways which can be used to improve the directional performance of the body-worn system.

One way is to estimate the transfer function (e.g. look vector/RTFs) from source to microphone while the person wearing the body-worn microphone unit is talking. The transfer function may e.g. be determined during phone conversations, because the person is likely to talk, if the far-away line is quiet. In an embodiment, at least one of the left and right hearing devices HD_{L} and HD_{R}, are configured to receive a direct electric audio signal from a telephone (representing the voice of a far-end communication partner). In an embodiment, at least one of the left and right hearing devices comprises a voice activity detector for determining whether (or with which probability) a voice is present in the received direct electric audio signal (the telephone signal).

Another way to estimate the transfer function from source to microphone is to use the hearing devices (e.g. hearing instruments) to determine when own-voice is present (presuming that the user wears hearing devices in a functional state). In an embodiment, one or both of the left and right hearing devices (HD_{L}, HD_{R}) comprise a voice activity detector for detecting whether a signal picked up by a microphone of the hearing device comprises a human voice. In an embodiment, the hearing device comprises a dedicated own voice detector adapted for indicating when a user's voice is present (either binary (1, 0) or with a certain probability [0, 1]). In an embodiment, the hearings device(s) and the microphone unit are adapted to establish a communication link between them allowing e.g. voice activity information to be exchanged between them.

Instead of (or in addition to) adaptively estimating the look vector d (RTFs), it is proposed to estimate a distance (D) or time delay (Δt) and possibly a direction (θ) from the microphone unit to the mouth of the user. In an embodiment, the hearing system comprises or has access to a dictionary of corresponding values of distance D (or time delay Δt) and possibly direction θ and sets of frequency dependent beamformer weights w(D, k) (or w(Δt, k)) or w(D, θ, k) (or w(Δt, θ, k)), k=1, . . . , K, where K is the number of frequency sub-bands. Each set of stored beamformer weights corresponds (in an approximation) to a range of distances (or time delays and possibly angles) around a central value. In an embodiment, the hearing system is configured to determine a current distance D′ from the user's mouth to the microphone unit and to select a set of beamformer weights w(D″, k) from the dictionary, where D″ is the distance that is closest to the current (estimated) distance D′, and to apply the set of beamformer weights to the beamformer filtering unit. This has the advantage that only one distance (or time delay, and optionally one angle) needs to be determined (a distance from the mouth to a fix point in the microphone unit, e.g. to a microphone, e.g. the closest one, e.g. M1 in FIG. 2A, 2B or to a midpoint between the two microphones (D1 as shown in FIG. 2A, 2B)). If the look vector is determined, frequency dependent transfer functions (e.g. d₁(k), d₂(k) for microphones M1 and M2) to each microphone (M1, M2) (or one relative transfer function (d₂(k)/d₁(k)) from M1 to M2, if M1 is assumed to be the reference microphone), and frequency dependent inter microphone noise covariance matrices have to be determined to provide current beamformer weights w(k,m), m being a (current) time index.

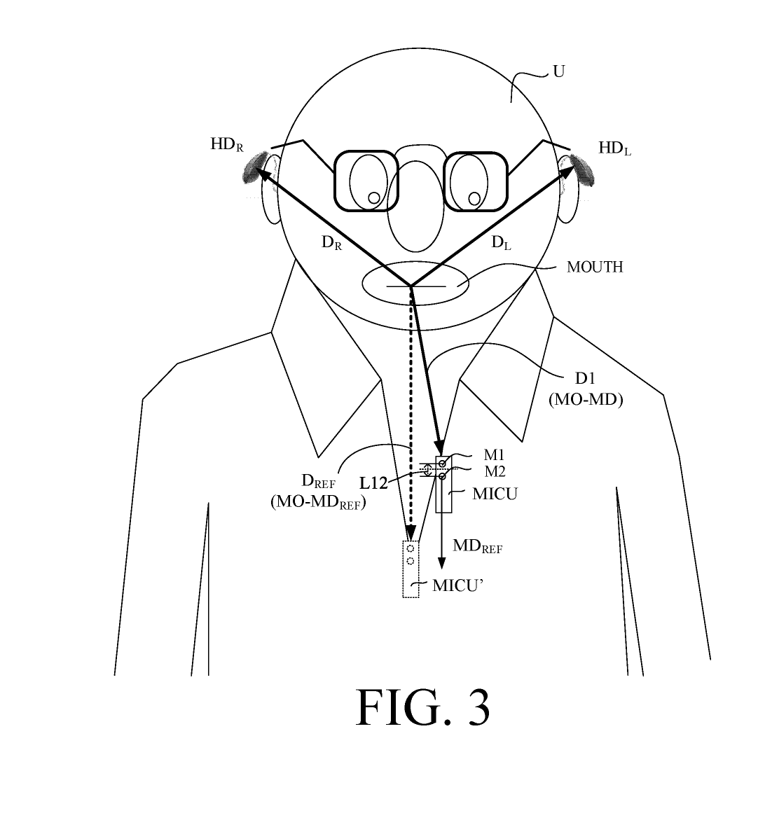

A distance between the mouth and the microphone unit (or the microphones of the microphone unit) or the propagation delay for sound between the mouth and the microphone unit (or the microphones of the microphone unit) can e.g. be determined as outlined in the following. FIG. 3 shows a user wearing a hearing system comprising a pair of hearing devices and a microphone unit for picking up the user's own voice according to the present disclosure, and illustrates a scheme for determining a distance between the user's mouth and the microphones of a microphone unit. In the present context, it is assumed that the user wears a hearing device or a pair of hearing devices. In this case, we can use the fact that the distances D_{L} and D_{R} between the mouth and the left and right hearing instruments HD_{L} and HD_{R}, respectively, do typically not vary much from day to day (where the hearing instruments have been dismounted and mounted again). But the distance between the body worn microphone unit MICU and the mouth (MOUTH) may be different every time the body worn microphone unit is mounted. The microphone unit MICU is located on (e.g. fixed to) the user's body (e.g. to clothing, or otherwise attached to the user's body, e.g. using an elastic tape or ring). Knowing the approximate distance (D_{R}, D_{L}) between the mouth and the hearing instrument microphones, we may thus find the distance (D1) (or a corresponding time delay Δt) to the body-worn microphone unit (MICU). In an embodiment, the distance D1 (or time delay Δt) is estimated based on the cross correlation between the acoustic signal from one of the microphones of the microphone unit and the acoustic signal obtained from a microphone at the hearing instrument(s), see FIG. 3. Either we can find the absolute distance, if we know the distance(s) (D_{R}, D_{L}) between the mouth and the hearing instrument(s) (HD_{R}, HD_{L}). Alternatively, we can find a change in distance compared to a reference position (D_{REF}) of the body-worn microphone unit (cf. dotted outline denoted MICU′ in FIG. 3). In an embodiment, the reference location of the microphone unit has a well-defined distance (D_{REF}) and direction (MO-MD_{REF}) from the mouth of the user to the microphone unit (MICU′). In an embodiment, the reference direction (MO-MD_{REF}) of the reference location of the microphone unit (MICU′) is equal to the direction of the force of gravity (a vertical direction). In an embodiment, the hearing device(s) and the microphone unit are adapted to establish a communication link between them allowing e.g. information signals, e.g. including audio signals (or parts of audio signals, e.g. selected frequency bands), or cross-correlation values or time delays or voice activity indicators, etc., to be exchanged between them.

When the distance (D1 in FIG. 2, 3) from the user's mouth to the body worn microphone unit MICU is known, we can choose a set of directional coefficients (e.g. frequency dependent beamformer weights w(k), where k is a frequency band index), e.g. stored in a dictionary located in a memory of the microphone unit together with other sets of beamformer weights representing other distances), which take not only the time delay between the microphones of the microphone unit but also the distance-dependent attenuation between the microphones into account. It is assumed that the dictionary of beamformer weights w(D, k) are determined for different mouth to microphone distances (D) for a microphone unit having the same specifications (e.g. geometrical configuration, such as inter-microphone distance(s), L12 in FIG. 2A, 2B, 3) as the one worn by the user during normal operation.

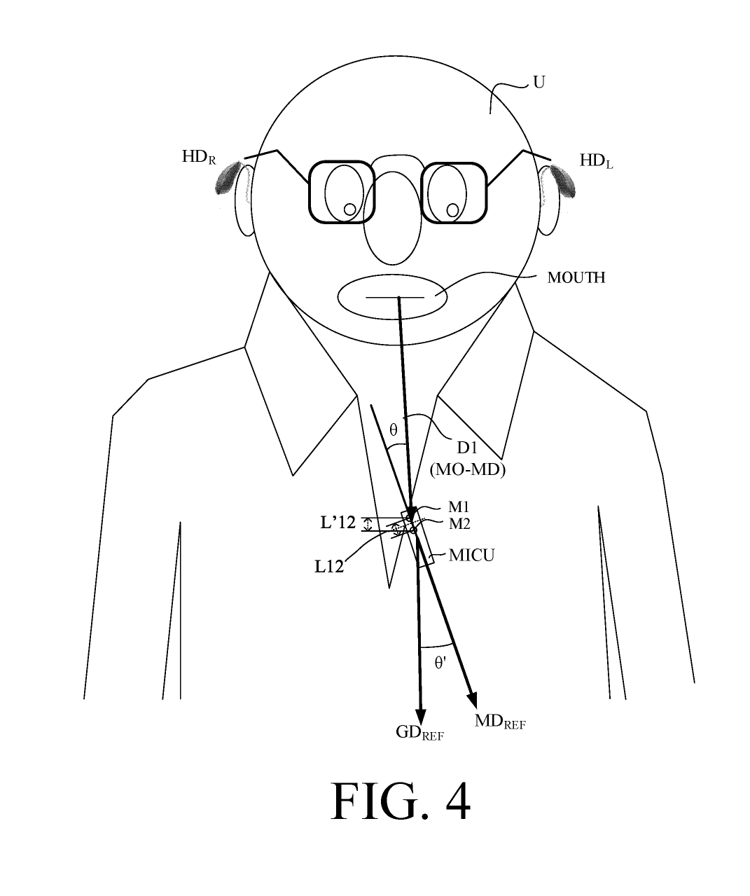

Furthermore, the microphone unit may be tilted (so that a reference direction MD_{REF} of the microphone unit (e.g. an axis between two microphones) is not pointing in the direction of the mouth of the user). FIG. 4 shows a user wearing a hearing system comprising a pair of hearing devices and a microphone unit for picking up the user's own voice according to the present disclosure, and illustrates a scheme for determining a direction of the microphone unit relative to a global reference direction. In this case, the look vector d not only depends on the distance D1 between the microphone unit and the mouth but also the angle θ between a reference direction of the microphone unit MD_{REF} and a direction from the microphone unit to the mouth represented by the bold arrow (in FIG. 4, distance D1 is taken to be from the mouth to the midpoint between the two microphones M1, M2). We may thus find the best suitable (e.g. frequency dependent) directional weights w(D, θ, k) depending on the inter-microphone distance (L12), the distance to the mouth (D1), and also on how much the microphone array is tilted (angle θ). Assuming that the body worn microphone array is positioned below the mouth (so that the mouth-to-microphone unit direction (MO-MD) is equal to or approximately equal to a vertical direction GD_{REF}, i.e. so that angle θ=angle θ′ in FIG. 4), we may estimate the microphone array tilt from a built-in accelerometer (e.g. a 3D accelerometer) or gyroscope as the angle (θ′) between the reference direction MD_{REF} of the microphone unit and the direction of gravity. The effective inter-microphone distance (L′12) considering the current tilt angle θ is shown in FIG. 4 (L′12=L12·cos θ) and form part of the current distances (D(M1), D(M2)) between mouth and microphones M1 and M2, respectively, where D(M1)=D1−½L′12, and D(M2)=D1+½L′12.

As mentioned above, a dictionary of beamformer weights w(D, θ, k) accessible to the hearing system may allow a dynamic update of the beamformer filtering unit, purely based on the mouth to microphone unit distance and the tilt angle (without determining the look vector and inter-microphone noise covariance matrix).

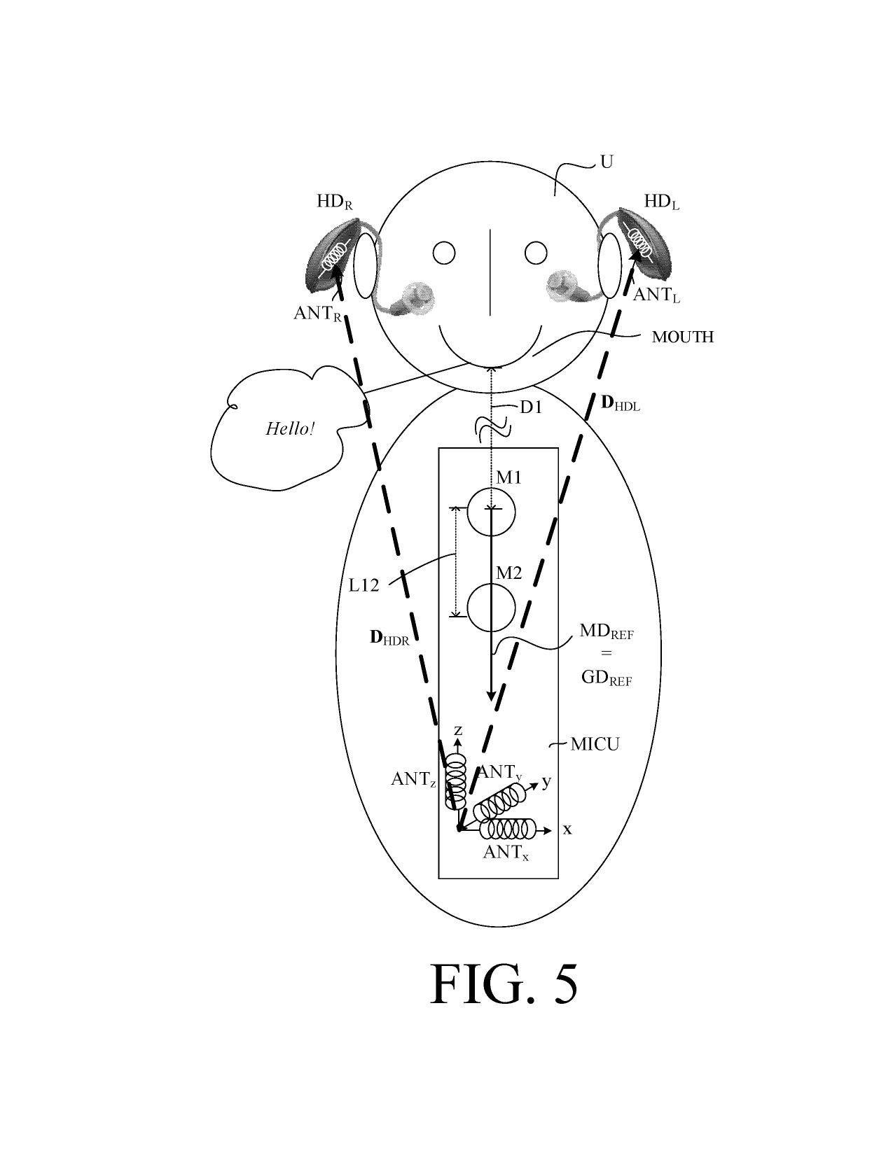

If the body-worn microphone device contains a magnetic wireless link, with two or three orthogonal coils we can, based on the signal strength at each coil, determine not only the distance to the hearing instruments, but also the angle of the device with respect to the hearing instruments, and hereby also the mouth. This is illustrated in FIG. 5.

FIG. 5 shows a user wearing a hearing system comprising a pair of hearing devices and a microphone unit for picking up the user's own voice according to the present disclosure, and illustrates a situation where a wireless link between the microphone unit and the hearing devices is based on magnetic induction.

In the embodiment of FIG. 5, the body-worn microphone unit MICU contains antenna and transceiver circuitry for establishing a magnetic induction link to the left and right hearing devices HD_{L}, HD_{R}. The antenna of the microphone unit MICU comprises several inductor coils whose coil axes are angled relative to each other. In the embodiment of FIG. 5 the antenna comprises three mutually orthogonal (3D) inductor coils ANTₓ, ANT_{y}, ANT_{z}, respectively, having their respective coil axes parallel to x, y and z axes of an orthogonal coordinate system. Each of the left and right hearing devices HD_{L}, HD_{R} correspondingly comprises an antenna comprising at least one (e.g. a single) inductor coil configured to couple inductively to the antenna of the microphone unit MICU to allow the establishment of an inductive communication link between them. By considering the signal strength received at the different antenna coils of the microphone unit from the left and right hearing devices respectively, it is not only possible to estimate the distance to the respective hearing devices, but also an orientation of the 3D coil antenna (ANTₓ, ANT_{y}, ANT_{z}) of the microphone unit relative to one of, or each of, the coil antenna (ANT_{L}, ANT_{R}) of the left and right hearing instruments HD_{L}, HD_{R}. Assuming that the orientation of the coil-axes of the antenna coils of the hearing instruments when mounted on the user U is (at least approximately) known (e.g. relative to a global reference direction GD_{REF}) and assuming that the orientation of the antenna coils of the microphone unit relative to the reference axis (MD_{REF}) of the microphone unit is known (a design option), an orientation (e.g. angle θ) of the microphone unit relative to the global reference direction GD_{REF} (e.g. the direction of the force of gravity) can be determined. The distance and direction from the microphone unit to the respective left and right hearing instruments HD_{L}, HD_{R} are indicated by dashed bold arrows (vectors) D_{HDL} and D_{HDR}, respectively. In an embodiment, a transmitted field strength is transmitted from the left and right hearing instruments HD_{L}, HD_{R} to the microphone unit, and the received field strengths at each coil of the 3D antenna of the microphone unit are measured. An estimate of the mutual orientation (at a given time) of transmission and reception antennas of two portable devices (worn by the same person) between which a wireless link is established is e.g. discussed in EP2838210A1. Thereby an orientation of the microphone unit (e.g. angle θ) relative to a global reference direction GD_{REF} can be estimated.

In an embodiment, the multi-input beamformer filtering unit (of the microphone unit) comprises an MVDR filter providing filter weights w_{mvdr}(k,m), said filter weights w_{mvdr}(k,m) being based on a look vector d(k,m) and an inter-input unit (e.g. inter-microphone) covariance matrix Rᵥᵥ(k,m) for the noise signal (the noise signal being e.g. the received signal when the user is NOT speaking), where k and m are frequency band and time frame indices, respectively.

In an embodiment, the multi-input noise reduction system is configured to adaptively estimate a current look vector d(k,m) of the beamformer filtering unit for a target signal originating from a target signal source located at a specific location relative to the user. In a preferred embodiment, the specific location relative to the user is the location of the user's mouth.

The look vector d(k,m) is an M-dimensional vector comprising elements (i=1, 2, . . . , M), the i^{th} element dᵢ(k,m) defining an acoustic transfer function from the target signal source (at a given location relative to the input units (microphones) of the microphone unit) to the i^{th} input unit (e.g. a microphone), or the relative acoustic transfer function from the i^{th} input unit (microphone) to a reference input unit (microphone). The vector element dᵢ(k,m) is typically a complex number for a specific frequency (k) and time unit (m). The look vector d(k,m) may be estimated from the inter input unit covariance matrix \hat{R}ₛₛ(k,m) based on signals sᵢ(k,m), i=1, 2, . . . , M from a signal source measured at the respective input units (microphones) when the source is located at the given location (e.g. the location of the user's mouth).

The determination of the look vector d(k,m) from the inter microphone covariance matrix \hat{R}ₛₛ(k,m) and the determination of the beamformer filter weights w_{mvdr}(k,m) from look vector d(k,m) and an inter-microphone noise covariance matrix Rᵥᵥ(k,m) are e.g. described in [Kjems and Jensen; 2012].

In an embodiment, a number of sets of default beamformer weights w_{mvdr}(Dₚ, k) (corresponding to a number of different distances Dₚ (p=1, . . . , N_{D}) (and/or directions θ_{q}, q=1, . . . , N_{θ}) between the mouth and the microphones of the microphone unit) are determined in an offline calibration process, e.g. conducted in a sound studio with a head-and-torso-simulator (e.g. HATS, Head and Torso Simulator 4128C from Brad & Kjaer Sound & Vibration Measurement A/S) with play-back of voice signals from the dummy head's mouth, and a microphone unit mounted in a number of different positions on the “chest” of the dummy head (corresponding to said distances Dᵢ). In an embodiment, the sets of default beamformer weights are determined from measurements on the user (instead of the simulator). In an embodiment, the default beamformer weights are stored in a memory of the hearing system, e.g. of the microphone unit. In this way, an appropriate set of beamformer weights can be chosen and applied, when a current distance D′ (and/or angle θ′) has been determined.

In an embodiment, the beamformer weights w_{mvdr}(k/m) are adaptively determined or selected.

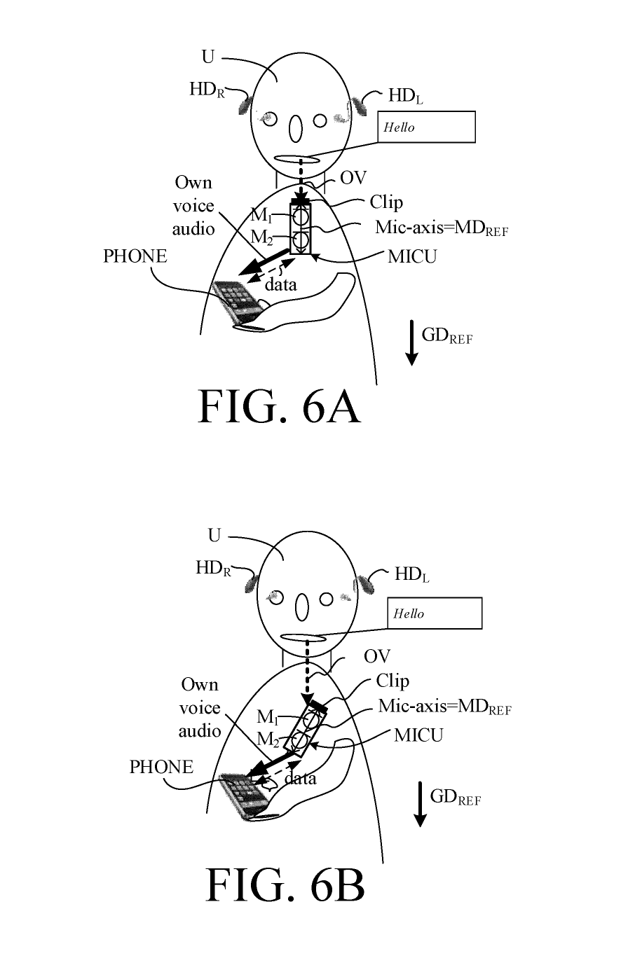

FIGS. 6A and 6B illustrate two different locations and orientations of a microphone unit on a user (cf. FIGS. 3 and 4). The sketches are intended to illustrate that the microphone unit (MICU) may be attached to a variable surface (e.g. clothes, e.g. on the chest, etc.) of the user (U), so that the position/direction of the microphone unit (MICU) relative to the user's mouth may change over time. As a consequence, the beamformer-noise reduction should preferably be adaptive to such changes as described in the present disclosure (and more specifically in EP2701145A1). With reference to FIGS. 1A, and 1B, FIG. 6A, 6B show a user U wearing a pair of hearing aids (HD_{L}, HD_{R}) and having a microphone unit (MICU) attached to the body below the head, e.g. via an attachment element, e.g. a clip (Clip). The microphone unit is configured to pick up the user's own voice OV (cf. bold dashed arrow from the user's mouth the microphone unit) and to transmit a corresponding signal (Own voice audio, cf. bold arrow) to the telephone device (PHONE). The microphone device and the telephone device are configured to be able to exchange other data than audio (cf. thin dashed arrow denoted ‘data’). A microphone axis (Mic-axis) of the two microphones (M1, M2) is indicated in the two embodiments (and is equal to a reference axis MD_{REF} of the microphone unit). The look vector d(k,m) is in this case a 2-dimensional vector comprising elements (d₁, d₂) defining an acoustic transfer function from the target signal source (Hello, the mouth of the user, U) to the microphones (M1, M2) of the microphone unit (MICU) (or the relative acoustic transfer function from one of the microphones to the other, defined as a reference microphone). FIG. 6A may represent a (predefined) reference location of the microphone unit for which a predetermined (reference) look vector (and possibly inter-microphone covariance matrix, and/or corresponding beamformer filter weights) has been determined. In FIG. 6A, the microphone reference axis MD_{REF} is parallel to the force of gravity (i.e. vertical), which is indicated in FIG. 6A, 6B as a global reference direction GD_{REF}. FIG. 6B may illustrate a location of the microphone unit which deviates from the reference location. Hence, in the scenario of FIG. 6B, the adaptive beamformer filtering unit has to provide or use an update of the look vector (at least, and preferably also the noise power estimates or noise covariance matrices). Such adaptive update of the beamformer weights is described in the present disclosure and further detailed out in [Kjems and Jensen; 2012] or in EP2701145A1. Alternatively, a dictionary of different predetermined sets of look vectors, noise covariance matrices and/or beamformer filtering weights corresponding to different distances (and possibly directions) from the microphone unit to the mouth of the user may be stored in a memory of the hearing system and appropriate values selected and applied to the beamformer in a given situation.

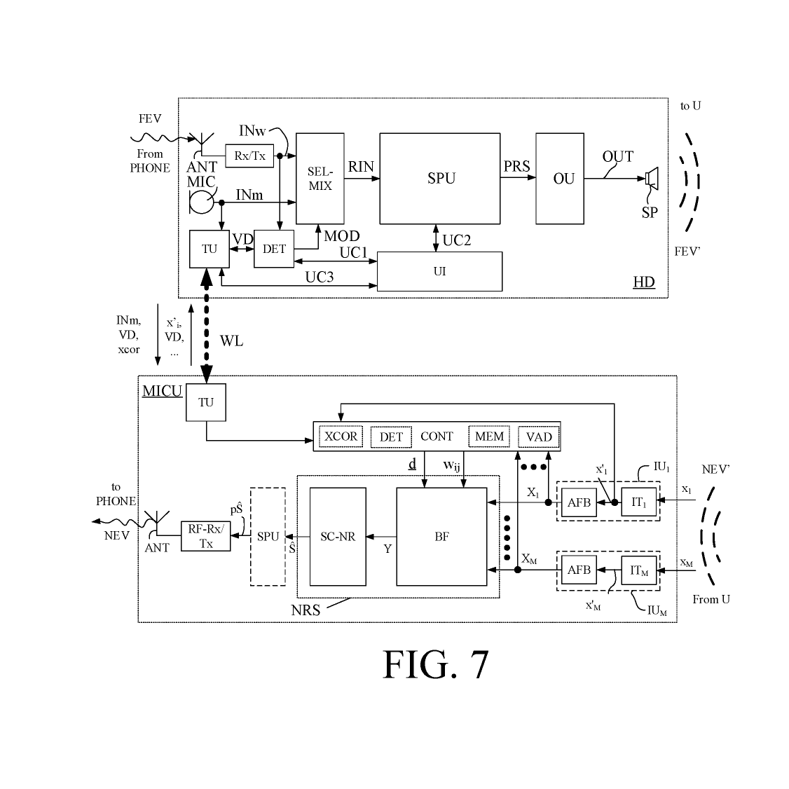

FIG. 7 shows a hearing system comprising a hearing device (HD) adapted for being located at or in an ear of a user, or adapted for being fully or partially implanted in the head of the user, and a separate microphone unit (MICU) adapted for being located at said user and picking up a voice of the user. The microphone unit (MICU) comprises a multitude M of input units IUᵢ, i=1, 2, . . . , M, each being configured for picking up or receiving a signal xᵢ (i=1, 2, . . . , M) representative of a sound NEV′ from the environment of the microphone unit (ideally from the user U, cf. reference From U in FIG. 7) and configured to provide corresponding electric input signals Xᵢ in a time-frequency representation in a number of frequency bands and a number of time instances. M is larger than or equal to two. In the embodiment of FIG. 7, input units IU₁-IU_{M} are shown to comprise respective input transducers IT₁-IT_{M} (e.g. microphones) for converting input sound x₁-x_{M} to respective (e.g. digitized) electric input signals x′₁-x′_{M} and each their filter banks (AFB) for converting electric (time-domain) input signals x′₁-x′_{M} to respective electric input signals X₁-X_{M} in a time-frequency representation (k,m). All M input units may be identical to IU₁ and IU_{M} or may be individualized, e.g. to comprise individual normalization or equalization filters and/or wired or wireless transceivers. In an embodiment, one or more of the input units comprises a wired or wireless transceiver configured to receive an audio signal from another device, allowing to provide inputs from input transducers spatially separated from the microphone unit, e.g. from one or more microphones of one or more hearing devices (HD) of the user (or from another microphone unit). The time-frequency domain input signals (Xᵢ, i=1, 2, . . . , M) are fed to a control unit (CONT) and to a multi-input noise reduction system (NRS) for providing an estimate Ŝ of a target signal s comprising the user's voice. The multi-input noise reduction system (NRS) comprises a multi-input beamformer filtering unit (BF) operationally coupled to said multitude of input units IUᵢ, i=1, . . . , M, and configured to determine (or apply) filter weights w(k,m) for providing a beamformed signal Y, wherein signal components from other directions than a direction of a target signal source (the user's voice) are attenuated, whereas signal components from the direction of the target signal source are left un-attenuated or are attenuated less relative to signal components from other directions. The multi-channel noise reduction system (NRS) of the embodiment of FIG. 7 further comprises a single channel noise reduction unit (SC-NR) operationally coupled to the beamformer filtering unit (BF) and configured for reducing residual noise in the beamformed signal Y and providing the estimate Ŝ of the target signal (the user's voice). The microphone unit may further comprise a signal processing unit (SPU, dashed outline) for further processing the estimate Ŝ of the target signal and provide a further processed signal pŜ. The microphone unit further comprises antenna and transceiver circuitry ANT, RF-Rx/Tx) for transmitting said estimate Ŝ (or further processed signal pŜ) of the user's voice to another device, e.g. a communication device (her indicated by reference ‘to Phone’, essentially comprising signal NEV, near-end-voice, i.e. the user's voice). The transceiver unit (or the signal processing unit) may comprise a synthesis filter bank to provide the estimate of the user's voice or the further processed/transmitted signal as a time domain signal. In an embodiment, the signal NEV is transmitted as a time-frequency domain signal.

The microphone unit comprises a control unit (CONT) configured to provide control of the multi-input beamformer filtering unit. The control unit (CONT) comprises a memory (MEM) storing reference values of a look vector (d) (and possibly also reference values of the noise-covariance matrices, and/or resulting beamformer weights wᵢⱼ). In an embodiment, a dictionary of exemplary look vectors (and/or noise-covariance matrices, and/or resulting beamformer weights w(D, θ, k)) for relevant locations of the microphone unit on the user's body, are stored in the memory (MEM). In an embodiment, the control unit (CONT) is configured to determine a current location of the microphone unit (MICU) on the user's body relative to the user's mouth. In an embodiment, the control unit is configured to select an appropriate look vector d and/or set of beamformer weights wᵢⱼ(D, θ, k) from the dictionary based on the currently determined location of the microphone unit. The control unit (CONT) comprises a correlation unit, e.g. a cross correlation unit, (XCOR) for determining a cross-correlation between a microphone signal INm of the hearing device (HD) (received from the hearing device via wireless link WL between the hearing device and the microphone unit (cf. dashed bold arrow in FIG. 7, established by respective transceiver units TU)) and one of the microphone signals (e.g. x′₁) of the microphone unit (here x′₁ from input transducer IT₁) (e.g. microphone M1 in FIG. 3). The cross-correlation is used to determine a difference in time of arrival (tₐ) of acoustic signals from the user's mouth to the respective microphones (thereby identifying the time difference Δt(HD-MICU)=tₐ(HD)−tₐ(MICU) that provides an optimal value of the cross-correlation (=the time lag that provides a maximum in the cross-correlation). Knowing the distance D_{R} (and/or D_{L}) between the user's mouth and the hearing device (HD_{R}, HD_{L}) (see FIG. 3), such values being e.g. determined in advance and stored in the memory (MEM), the distance D1 between the user's mouth and a microphone of the microphone unit (M1) can be determined as D1=D_{L} (or D_{R})−Δt(HD-MICU)·cₐᵢᵣ, where cₐᵢᵣ is the velocity of sound in air. The control unit (CONT) further comprises a detector (DET), e.g. for determining an orientation of the microphone unit (MICU) relative to a reference direction (e.g. global reference direction GD_{REF}, cf. e.g. FIG. 4). The detector may e.g. comprise an acceleration sensor (e.g. an accelerometer, such as a 3D accelerometer), and/or an orientation sensor (e.g. a gyroscope) or a detector based on the relative antenna orientations of a magnetic communication link as described in connection with FIG. 5. The control unit (CONT) further comprises a voice activity detector (VAD) and/or is adapted to receive information (estimates) about current voice activity of the user and/or of the far end person currently engaged in a telephone conversation with the user (cf. signal VD from the hearing device, which monitors voice activity on the wirelessly received signal INw received from an external telephone (PHONE in FIG. 1A, 1B)). Voice activity information can e.g. be used to provide an adaptive noise reduction system (NRS) to control the timing of the update of the noise reduction system (update look vector d when user speaks, and noise covariance matrix Rᵥᵥ when the user does not speak, the latter being e.g. indicated by a detection of voice activity in the wirelessly received signal).

In the embodiment, of FIG. 7, the determination of cross correlation is performed in the unit XCOR in the control unit CONT located in the microphone unit MICU. In another embodiment, the determination of cross correlation (or time delay Δt) may be performed in the hearing device HD (e.g. in detector unit DET, which should then receive a microphone signal x′ᵢ from the microphone unit) and transmitted to the microphone unit (cf. signal xcor). Thereby the burden of transmitting a microphone signal (cf. signal x′ᵢ) to another device is on the microphone unit (which is typically larger than a hearing device and thus may have a larger battery capacity). Since reception generally requires less power than transmission in a wireless link (and the transmitted correlation (or time delay) requires much less bandwidth than the audio signal from the microphone), this partition of tasks may be advantageous from a hearing device power budget point of view.

The wireless link (WL) between the hearing device (HD) and the microphone unit (MICU) may be based on near-field communication or radiated fields. The respective antenna and transceiver units (TU) for implementing the wireless link (WL) may comprise antenna coils as shown and discussed in connection with FIG. 5. In an embodiment, information related to an orientation of the microphone unit relative to a reference direction is exchanged between the hearing device and the microphone unit. In an embodiment, information related to the signal (field) strengths or power levels transmitted and/or received by the respective antenna coils is exchanged between the hearing device and the microphone unit. In an embodiment, the control unit (CONT) of the microphone unit is configured to determine the current orientation of the microphone unit based (at least in part) on the exchanged signal (field) strengths or power levels. An estimate of the mutual orientation (at a given time) of transmission and reception antennas of two portable devices (worn by the same person) between which a wireless link is established is e.g. discussed in EP2838210A1.

In an embodiment, the signals transmitted from the hearing device to the microphone unit via the wireless link (WL) are re- or down-sampled and/or transmitted only in selected time windows to save power. This may be an allowable simplification, because the change in location or orientation of the microphone unit will generally be relatively slow. In an embodiment, the microphone signal INm of the hearing device (HD) transmitted via wireless link WL to the microphone unit is band-pass filtered to reduce the necessary bandwidth of the link (and thus power in the hearing device).

The hearing device (HD, e.g. HD_{L} or HD_{R} in FIG. 1-6) comprises an input transducer, e.g. microphone (MIC), for converting an input sound to an electric input signal INm. The hearing device may comprise a directional microphone system (e.g. a multi-input beamformer and noise reduction system as discussed in connection with the microphone unit, not shown in the embodiment of FIG. 7) adapted to enhance a target acoustic source in the user's environment among a multitude of acoustic sources in the local environment of the user wearing the hearing device (HD). Such target signal (for the hearing device) is typically NOT the user's own voice. In a specific communication mode of operation (as described in the present disclosure), where the user's own voice is picked up by the microphone unit (MICU), the microphone signal INm may be transmitted to another device (here to the microphone unit) via transceiver unit (TU) for establishing wireless link WL. The hearing device (HD) further comprises an antenna (ANT) and transceiver circuitry (Rx/Tx) for wirelessly receiving a direct electric input signal from another device, e.g. a communication device, here indicated by reference ‘From PHONE’ and signal FEV (far-end-voice) referring to the telephone conversation scenarios of FIG. 1A, 1B. The transceiver circuitry comprises appropriate demodulation circuitry for demodulating the received direct electric input to provide the direct electric input signal INw representing an audio signal (and/or a control signal). The hearing device (HD) further comprises a selection and/or mixing unit (SEL-MIX) allowing to select one of the electric input signals (INw, INm) or to provide an appropriate mixture as a resulting input signal RIN. The selection and/or mixing unit (SEL-MIX) is controlled by detection and control unit (DET) via signal MOD determining a mode of operation of the hearing device (in particular controlling the SEL-MIX-unit). The detection and control unit (DET), may e.g. comprise a detector for identifying the mode of operation (e.g. for detecting that the user is engaged or wish to engage in a telephone conversation) or is configured to receive such information, e.g. from an external sensor and/or from a user interface (UI, via signal UC1). The detector unit (DET) may further comprise a voice detector for monitoring a voice activity in the wirelessly received signal INw and for transmitting an indication thereof via wireless link WL (and signal VD) to the microphone unit (MICU). The input signals INw and INm may be in the time domain or in the time-frequency domain, according to the particular application in the hearing device (HD).

The hearing device further comprises a signal processing unit (SPU) for processing the resulting input signal RIN and is e.g. adapted to provide a frequency dependent gain and/or a level dependent compression and/or a transposition (with or without frequency compression) of one or more frequency ranges (bands) to one or more other frequency ranges (bands), e.g. to compensate for a hearing impairment of a user. The signal processing unit (SPU) provides a processed signal PRS. The hearing device further comprises an output unit (OU) for providing a stimulus OUT configured to be perceived by the user as an acoustic signal based on a processed electric signal PRS. In the embodiment of FIG. 7, the output transducer comprises a loudspeaker (SP) for providing the stimulus OUT as an acoustic signal to the user (here indicated by reference ‘to U’ and signal FEV′ (far-end-voice) referring to the telephone conversation scenarios of FIG. 1A, 1B. The hearing device may alternatively or additionally comprise a number of electrodes of a cochlear implant or a vibrator of a bone conducting hearing device.

The hearing system (here indicated in the hearing device (HD)) comprises a user interface (UI) allowing a user to influence functionality of the system (hearing device(s) and/or microphone unit), e.g. to enter and/or leave a mode of operation, e.g. a communication (e.g. telephone) mode. The user interface may further allow information about the current mode of operation or other information to be presented to the user, e.g. via a remote control device, such as a smartphone or other communication device with appropriate display and/or processing capabilities. Such information may include information from the microphone unit (MICU), as e.g. indicated by thin arrow in the wireless link WL from the microphone unit to the hearing device (HD) (optional microphone signals x′ᵢ and voice detecting signal VD, etc.) and further to the user interface (UI) via signal UC3.

The embodiment of a hearing system as illustrated in FIG. 7 may e.g. exemplify a ‘near-end’ part of the scenario of FIG. 1B.

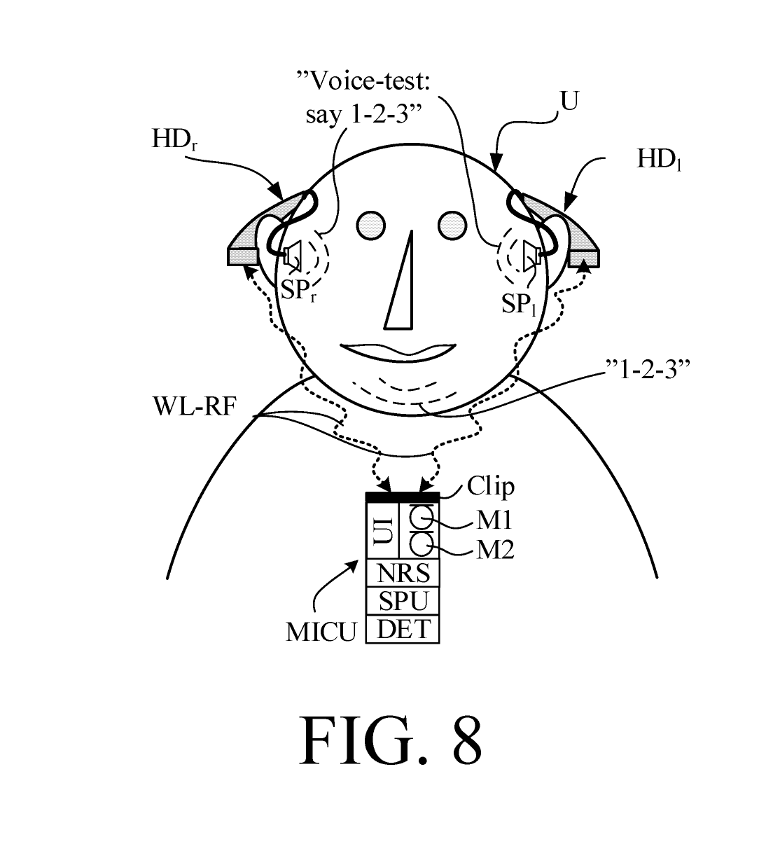

FIG. 8 illustrates a scenario for updating distances or time delays or relative transfer functions (and hence the beamformer filtering weights) at a specifically selected point in time (during a ‘user speech test’). The user U wearing the hearing system (comprising left and right hearing devices (HDₗ, HDᵣ) and microphone unit (MICU)) is instructed via loudspeakers (SPₗ, SPᵣ) of the respective hearing devices (HDₗ, HDᵣ) to initiate a user speech test (cf. acoustic instruction “Voice test: say 1-2-3”). Alternatively, the user may be instructed by other means, e.g. via an APP of a smartphone. The hearing system (e.g. the signal processor (SPU)) is e.g. configured to generate the instruction when the detector (DET, e.g. a comprising a level detector) indicates that the sound level at the microphone unit is below a predefined (background) threshold level (L_{bg}), where it can be assumed that the user's own voice is NOT present. During the user speech test, where the user speaks (e.g. “1-2-3”), the parameters related to a current geometric configuration of the microphone unit relative to the mouth of the user (e.g. RTFs, D, Δt) are updated. The updated parameters are used to select (or determine) relevant beamformer filtering weights of the noise reduction system (NRS) of the microphone unit. The user speech test may alternatively or additionally be initiated via the user interface UI of the microphone unit (MICU).

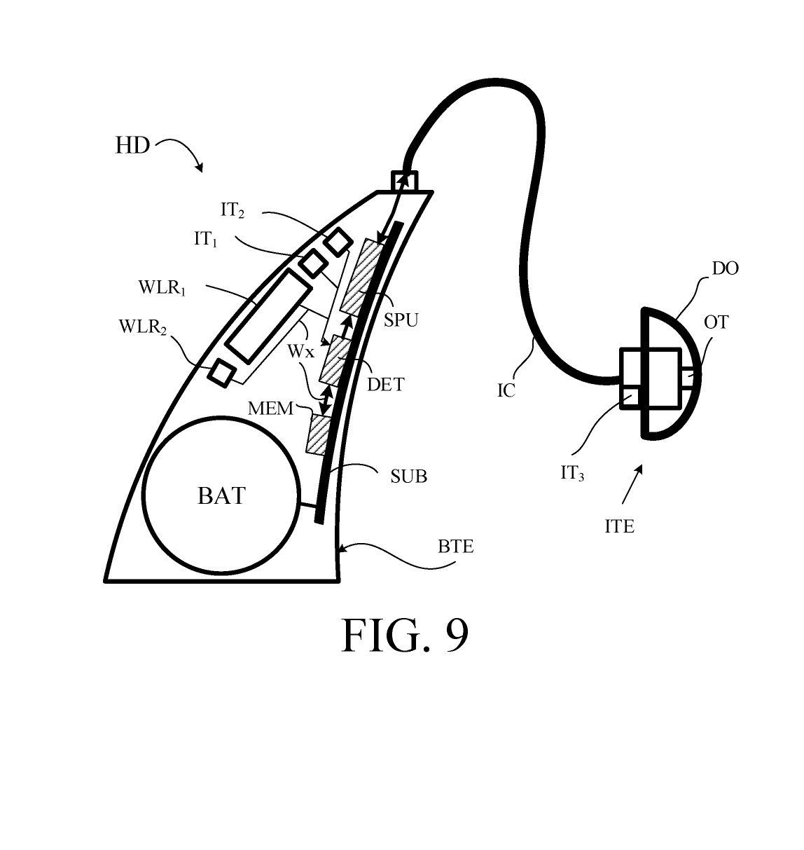

FIG. 9 shows an exemplary hearing device according to the present disclosure. The hearing device (HD), e.g. a hearing aid, is of a particular style (sometimes termed receiver-in-the ear, or RITE, style) comprising a BTE-part (BTE) adapted for being located at or behind an ear of a user and an ITE-part (ITE) adapted for being located in or at an ear canal of a user's ear and comprising an output transducer (OT), e.g. a receiver (loudspeaker). The BTE-part and the ITE-part are connected (e.g. electrically connected) by a connecting element (IC) and internal wiring in the ITE- and BTE-parts (cf. e.g. schematically illustrated as wiring Wx in the BTE-part). The BTE- and ITE-parts each comprise an input transducer, IT1 and IT2, respectively, which are used to pick up sounds from the environment of a user wearing the hearing device. In an embodiment, the ITE-part is relatively open allowing air to pass through and/or around it thereby minimizing the occlusion effect perceived by the user. In an embodiment, the ITE-part according to the present disclosure is less open than a typical RITE-style comprising only a loudspeaker (OT) and a dome (DO) to position the loudspeaker in the ear canal. In an embodiment, the ITE-part according to the present disclosure comprises a mould and is intended to allow a relatively large sound pressure level to be delivered to the ear drum of the user (e.g. a user having a severe-to-profound hearing loss).

In the embodiments of a hearing device (HD) in FIG. 9, the BTE part comprises an input unit comprising two input transducers (e.g. microphones, IT₁, IT₂) each for providing an electric input audio signal representative of an input sound signal. The input unit further comprises two (e.g. individually selectable) wireless receivers (WLR₁, WLR₂) for providing respective directly received auxiliary audio input and/or control or information signals. The BTE-part comprises a substrate SUB whereon a number of electronic components (here MEM, DET, SPU) are mounted. The BTE-part comprises one or more detectors (DET), e.g. configured to control or influence processing in the hearing device. The BTE-part further comprises a configurable signal processing unit (SPU) comprising a processor and memory and adapted for selecting and processing one or more of the electric input audio signals and/or one or more of the directly received auxiliary audio input signals, based on a currently selected (activated) hearing aid program/parameter setting (e.g. either automatically selected based on one or more detectors (DET) and/or on inputs from a user interface). The configurable signal processing unit (SPU) provides an enhanced audio signal. In an embodiment, the signal processing unit (SPU) form part of an integrated circuit, e.g. a digital signal processor. In an embodiment, the hearing device comprises a separate memory chip (MEM) comprising hearing aid parameters (e.g. related to beamforming) and programs.

The hearing device (HD) further comprises an output unit (OT, e.g. an output transducer) providing an enhanced output signal as stimuli perceivable by the user as sound based on the enhanced audio signal from the signal processing unit or a signal derived therefrom. Alternatively or additionally, the enhanced audio signal from the signal processing unit may be further processed and/or transmitted to another device depending on the specific application scenario.

In the embodiment of a hearing device in FIG. 9, the ITE part comprises the output unit in the form of a loudspeaker (receiver) (OT) for converting an electric signal to an acoustic signal. The ITE-part also comprises a (third) input transducer (IT₃, e.g. a microphone) for picking up a sound from the environment. In addition, the (third) input transducer (IT₃) may—depending on the acoustic environment—pick up more or less sound from the output transducer (OT) (unintentional acoustic feedback). The ITE-part further comprises a guiding element, e.g. a dome or mould, (DO) for guiding and positioning the ITE-part in the ear canal of the user.

The hearing device, e.g. the signal processing unit (SPU), comprises e.g. a feedback cancellation system for reducing or cancelling feedback from the output transducer (OT) to the input transducers (e.g. to IT₃ and/or to the input transducers (IT₁, IT₂) of the BTE-part.

The hearing device (HD) exemplified in FIG. 9 is a portable device and further comprises a battery (BAT), e.g. a rechargeable battery, for energizing electronic components of the BTE- and ITE-parts. The hearing device of FIG. 9 may in various embodiments implement the embodiments of a hearing device shown in FIG. 1A, 1B, FIG. 2A, 2B, FIG. 3, FIG. 4, FIG. 5, FIG. 6A, 6B, FIG. 7, and FIG. 8, respectively.

In an embodiment, the hearing device, e.g. a hearing aid (e.g. the signal processing unit SPU), is adapted to provide a frequency dependent gain and/or a level dependent compression and/or a transposition (with or without frequency compression) of one or frequency ranges to one or more other frequency ranges, e.g. to compensate for a hearing impairment of a user.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element but an intervening elements may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method is not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more.

Accordingly, the scope should be judged in terms of the claims that follow.

### REFERENCES

EP2701145A1 (Retune, Oticon) Feb. 26, 2014
[Kjems and Jensen; 2012] U. Kjems, J. Jensen, “Maximum likelihood based noise covariance matrix estimation for multi-microphone speech enhancement”, 20th European Signal Processing Conference (EUSIPCO 2012), pp. 295-299, 2012.
EP2838210A1 (Oticon) Feb. 18, 2015
EP2882204A1 (OTICON) Jun. 10, 2015
[Farmani et al.; 2017] Mojtaba Farmani, Michael Syskind Pedersen, Zheng-Hua Tan, and Jesper Jensen, Informed Sound Source Localization Using Relative Transfer Functions for Hearing Aid Applications, IEEE/ACM TRANSACTIONS ON AUDIO, SPEECH, AND LANGUAGE PROCESSING, VOL. 25, NO. 3, pp. 611-623, 2017.

1. A body worn hearing system comprising a hearing device, e.g. a hearing aid, adapted for being located at or in an ear of a user, or adapted for being fully or partially implanted in the head of the user, and a separate microphone unit adapted for being located at said user and picking up a sound, e.g. a voice of the user, from the user's mouth, wherein
the hearing device comprises
a forward path comprising an input unit for receiving an electric audio signal and/or for generating an electric input signal representative of sound in an environment of the hearing device, a signal processing unit for processing said electric audio signal or said electric input signal or a mixture thereof and providing a processed signal, and an output unit for generating stimuli perceivable as sound when presented to the user based on said processed signal, and
an antenna and transceiver unit for
establishing a communication link to a communication device and configured to receive an audio signal from the communication device, at least in a specific communication mode of operation of the hearing system, and for
establishing a communication link to the microphone unit for transmitting information to and/or receiving information from the microphone unit, and wherein
the microphone unit comprises
an input unit comprising a multitude M of microphones Mᵢ, i=1, . . . , M, each being configured for picking up or receiving a signal representative of a sound xᵢ(n) from the environment of the microphone unit and providing respective electric input signals x′ᵢ(n), n representing time, and M being larger than or equal to two; and
a multi-input noise reduction system for providing an estimate Ŝ of a target signal s comprising the user's voice, the multi-input noise reduction system comprises a multi-input beamformer filtering unit operationally coupled to said multitude of microphones Mᵢ, i=1, . . . , M, and configured to provide a spatially filtered signal; and
an antenna and transceiver unit for
establishing a communication link to the communication device and configured to transmit said estimate Ŝ of the user's voice to the communication device, at least in a specific communication mode of operation of the hearing system, and for
establishing a communication link to the hearing device for transmitting information to and/or receiving information from the hearing device,
wherein
the hearing system comprises a control unit configured to estimate
a current distance between the user's mouth and the microphone unit, or
a current time delay for propagation of sound from a user's mouth to the microphone unit, and/or
relative transfer functions from the user's mouth to each of the M microphones relative to a reference microphone among the M microphones, and
the hearing system is configured to control the multi-input noise reduction system in dependence of said current distance, or said current time delay, or said relative transfer functions.

2. A hearing system according to claim 1 wherein the control unit is configured to estimate a current distance or a current time delay from the user's mouth to the at least one, such as a majority or all, of the multitude M of microphones of the microphone unit, and/or said relative transfer functions.

3. A hearing system according to claim 1 wherein the microphone unit comprises a housing wherein or whereon the multitude M of microphones are located, the housing defining a microphone unit reference direction MD_{REF}.

4. A hearing system according to claim 1 wherein the antenna and transceiver unit of the hearing device comprises separate first and second antenna and transceiver units, wherein
the first antenna and transceiver unit is configured to establish the communication link to the communication device and to receive an audio signal from the communication device, at least in a specific communication mode of operation of the hearing system, and wherein
the second antenna and transceiver unit is configured to establish the communication link to the microphone unit for transmitting information to and/or receiving information from the microphone unit.

5. A hearing system according to claim 1 wherein the antenna and transceiver unit of the microphone unit comprises separate first and second antenna and transceiver units, wherein
the first antenna and transceiver unit is configured to establish the communication link to the communication device and to transmit said estimate S of the user's voice to the communication device, at least in a specific communication mode of operation of the hearing system, and wherein
the second antenna and transceiver unit is configured to establish the communication link to the hearing device for transmitting information to and/or receiving information from the hearing device.

6. A hearing system according to claim 1 wherein the control unit is configured to estimate a current orientation of the microphone unit relative to a direction from the microphone unit to the user's mouth, and wherein the hearing system is configured to control the multi-input noise reduction system in dependence of the orientation of the microphone unit relative to a direction from the microphone unit to the user's mouth.

7. A hearing system according to claim 1 wherein the input unit is configured to provide said time varying electric inputs signals x′ᵢ(n) as electric input signals Xᵢ(k,m) in a time-frequency representation comprising time varying signals in a number of frequency sub-bands, k being a frequency band index, m being a time index.

8. A hearing system according to claim 1 wherein the hearing device comprises a voice activity detector configured to determining whether, or with which probability, a voice is present in the direct electric audio signal received from the communication device.

9. A hearing system according to claim 1 wherein the microphone unit comprises a voice activity detector configured to determining whether, or with which probability, a voice, e.g. a voice of the user, is present in the spatially filtered signal or in one or more of the electric input signals representative of sound from the environment of the microphone unit.

10. A hearing system according to claim 1 comprising a detection unit is configured to detect a difference in acoustic propagation time between sound from the user's mouth to the hearing device and to microphone unit, respectively.

11. A hearing system according to claim 10 wherein the detection unit is configured to determine a cross correlation between sound from the user's mouth received at a microphone of the hearing device and sound received at one of the multitude M of microphones of the microphone unit.

12. A hearing system according to claim 1 wherein the antenna and transceiver units of the hearing device and the microphone unit each comprises respective antenna coils configured to have an inductive coupling to each other that allow an inductive communication link to be established between the hearing device and the microphone unit when the hearing device and the microphone unit are mounted on the user's body, and wherein at least one of the hearing device and the microphone unit comprises at least two mutually angled antenna coils.

13. A hearing system according to claim 1 configured to be able to access a dictionary of beamformer weights and corresponding mouth to microphone distances or time delays and optionally tilt angles.

14. A hearing system according to claim 1 comprising a memory wherein a dictionary of beamformer weights and corresponding mouth to microphone distances or time delays and optionally tilt angles is stored.

15. A hearing system according to claim 1 wherein the hearing device comprises a hearing aid.

16. A hearing system according to claim 1 wherein parameters related to a current geometric configuration of the microphone unit relative to the mouth of the user are estimated on initiation of a user, or as a standard procedure during power-on or use of the hearing system.

17. A hearing system according to claim 16 wherein the parameters related to a current geometric configuration of the microphone unit relative to the mouth of the user, are estimated under the condition that a detected environment sound level is below a threshold level.

18. A hearing system according to claim 16 wherein an activation of the estimation of the parameters related to a current geometric configuration of the microphone unit relative to the mouth of the user is indicated to the user, e.g. via a loudspeaker of the hearing device(s), as an invitation to the user to speak.

19. A hearing system according to claim 1 comprising first and second hearing devices adapted for being located at, or fully or partially implanted at or in, left and right ears, respectively, of the user, wherein said first and hearing devices form part of a binaural hearing system, wherein the left and right hearing devices each comprises antenna and transceiver circuitry allowing the exchange of information between them, such information including one or more of audio data and/or control signals and/or status signals.

20. A non-transitory application, termed an APP, comprising executable instructions configured to be executed on an auxiliary device to implement a user interface for a hearing system according to claim 1.

21. A non-transitory application according to claim 20 configured to allow a user to initiate a user speech test, where the user speaks, and where parameters related to a current geometric configuration of the microphone unit relative to the mouth of the user are updated.
